(19) United States
(12) Patent Application Publication
(10) Pub. No.: US 2025/0202882 A1
(43) Pub. Date: Jun. 19, 2025

(54) METHODS AND SYSTEMS FOR FACILITATING SINGLE SIGN-ON AND PASSWORDLESS SIGN-ON

(71) Applicant: AgileBits Inc. dba 1Password, Toronto (CA)

(72) Inventors: James Griffin-Allwood, Toronto (CA); Charles Adam Caudill, Toronto (CA); Mitchell Cohen, Toronto (CA); Richard Fillion, Toronto (CA); Camilo Garcia La Rotta, Toronto (CA); David Gunter, Toronto (CA); Christian Rask, Toronto (CA); Kenneth Edward Valencik, JR., Toronto (CA); Aidan Woods, Toronto (CA)

(21) Appl. No.: 18/539,858

(22) Filed: Dec. 14, 2023

(51) Int. Cl. H04L 9/40

(52) U.S. Cl. CPC H04L 63/0815; H04L 63/0435

(57) ABSTRACT

Computer-implemented methods and systems for facilitating single sign-on (SSO) and passwordless sign-on to a web service provider are provided. A client device authorized for SSO or passwordless sign-on generates and stores a device-specific key that it uses to encrypt a credential bundle containing key(s) necessary to access a cryptographically protected resource provided by the web service provider. The encrypted credential bundle is stored by the web service provider and provided to the authorized client device upon a successful authentication via SSO or passwordless sign-on. The authorized device uses the locally stored device-specific key to decrypt the encrypted credential bundle received from the web service provider to obtain the key(s) necessary to access the cryptographically protected resource.

### FIELD

The disclosed teachings relate generally to techniques for users to securely sign-on to a web service provider. More particularly, the disclosed teachings relate to techniques for facilitating single sign-on and passwordless sign-on to a web service provider.

### BACKGROUND

Authentication is the process of one entity proving its identity to another. Typically the authenticating party does this by proving to the verifying party that it knows a particular secret that only the authenticating party should know. Controlling access to a resource provided by a web service is typically done by requiring a user to authenticate with the web service by demonstrating that the user has access to one or more secrets (e.g., a password or other authentication factors, such as biometrics) only the user should have access to.

A given user may utilize multiple web services or applications that require such authentication in order to access. In the case of conventional password-controlled access, this can place a burden on the user to manage and keep track of a large number of passwords corresponding to the web services or applications utilized by the user.

Single Sign-On (SSO) procedures and passwordless sign-on procedures that utilize passkeys have been developed that can ease this burden and facilitate secure user authentication. However, conventional SSO and passwordless sign-on procedures to authenticate a user with a web service or application do not provide a way for a user to end up with a decryption key only the user knows that can be used for end-to-end encryption between the user and the web service or application.

Accordingly, there is a need for improved methods and systems for facilitating SSO and passwordless sign-on to web services in a manner that supports end-to-end encryption in order to maintain a zero-knowledge environment.

### SUMMARY

A first aspect of the present disclosure provides a computer-implemented method for facilitating single sign-on (SSO) to a web service provider. The method comprises: receiving, on a client device, user input to access a cryptographically protected resource provided by a web service provider; redirecting a user on the client device to perform a login to an identity provider; receiving, from the identity provider, a response to the login to the identity provider; sending the response from the identity provider to the web service provider; after the web service provider confirms validity of the identity of the user by the identity provider, receiving information conveying an encrypted credential bundle from the web service provider, the encrypted credential bundle corresponding to the user and the client device, wherein the encrypted credential bundle is symmetrically encrypted using a device key previously generated on the client device and corresponding to the user and the client device, the encrypted credential bundle including at least an encrypted first key; retrieving, from local storage on the client device, the device key corresponding to the user and the client device; decrypting the encrypted credential bundle using the device key to obtain the first key; and using the first key to access the cryptographically protected resource provided by the web service provider.

In some embodiments of the method according to the first aspect of the present disclosure, the encrypted credential bundle further includes at least an encrypted second key, the method further comprising: decrypting the encrypted credential bundle using the device key to obtain the second key; and using the second key to establish an authorized session for communication between the web service provider and the client device.

In some embodiments of the method according to the first aspect of the present disclosure: the web service provider is a vault service provider; the cryptographically protected resource is a vault provided by the vault service provider; and using the first key to access the cryptographically protected resource provided by the web service provider comprises using the first key to decrypt an encrypted chain of keys to unlock the vault provided by the vault service provider.

In some embodiments of the method according to the first aspect of the present disclosure: the encrypted credential bundle is symmetrically encrypted with a symmetric encryption key derived from the device key; and decrypting the encrypted credential bundle using the device key comprises: i) deriving a symmetric decryption key using the device key; and ii) decrypting the encrypted credential bundle with the symmetric decryption key.

In some embodiments of the method according to the first aspect of the present disclosure further comprises: after the web service provider confirms validity of the identity of the user by the identity provider, receiving information from the web service provider conveying a session identifier corresponding to an unverified session between the web service provider and the client device, wherein using the second key to establish an authenticated session for communication with the web service provider comprises using the second key to authenticate the unverified session corresponding to the session identifier received from the web service provider.

In some embodiments of the method according to the first aspect of the present disclosure, using the second key to establish an authenticated session for communication with the web service provider comprises using the first key in a password authenticated key exchange (PAKE) to establish the authenticated session for communication with the web service provider without revealing the first key to the web service provider.

In some embodiments of the method according to the first aspect of the present disclosure, using the second key in the PAKE to establish the authenticated session for communication with the web service provider comprises establishing a shared session key for end-to-end encrypted communication with the web service provider.

In some embodiments of the method according to the first aspect of the present disclosure, the PAKE is based on a secure remote password (SRP) protocol utilizing a verifier previously generated using the second key, wherein the verifier is stored on the web service provider.

In some embodiments of the method according to the first aspect of the present disclosure further comprises: before receiving the encrypted credential bundle from the web service provider, sending a key identifier (ID) to the web service provider for use in identifying the encrypted credential bundle corresponding to the user and the client device, wherein the key ID corresponds to the device key previously generated on the client device.

In some embodiments of the method according to the first aspect of the present disclosure, sending the key ID corresponding to the device key to the web service provider comprises: receiving a communication from the web service provider confirming validation of the identity of the user by the identity provider; and sending, to the web service provider, a request to provide the encrypted credential bundle corresponding to the user and the client device, wherein the request includes the key ID corresponding to the device key previously generated on the client device.

In some embodiments of the method according to the first aspect of the present disclosure, the encrypted credential bundle corresponds to the user, the client device and a specific account of the user, the method further comprising sending an account identifier to the web service provider for use in identifying the encrypted credential bundle corresponding to the user, the client device and the specific account of the user.

In some embodiments of the method according to the first aspect of the present disclosure, further comprises: after the web service provider confirms validity of the identity of the user by the identity provider, receiving a reauthentication token from the web service provider; storing the reauthentication token on the client device in an element that is accessible via a biometric access mechanism on the client device; prompting the user to provide biometric input via the biometric access mechanism on the client device to access the cryptographically protected resource provided by the web service provider; in response to the user providing biometric input via the biometric access mechanism such that the reauthentication token is accessible, retrieving the reauthentication token and sending the reauthentication token to the web service provider for validation; and after the web service provider confirms validity of the reauthentication token, receiving the encrypted credential bundle.

In some embodiments of the method according to the first aspect of the present disclosure, before redirecting the user on the client device to perform the login to the identity provider, performing an enrollment process to register the client device with the web service provider as a trusted device for SSO for the user, the enrollment process comprising: receiving, on the client device, user input to access the cryptographically protected resource provided by the web service provider; redirecting the user on the client device to perform a login to the identity provider; receiving, from the identity provider, a response to the login to the identity provider; sending the response from the identity provider to the web service provider; after the web service provider confirms validity of the identity of the user by the identity provider, generating the device key corresponding to the user and the client device; generating the first key; encrypting the first key using the device key to generate the encrypted credential bundle; and sending the encrypted credential bundle to the web service provider for storage in association with the user and the client device.

In some embodiments of the method according to the first aspect of the present disclosure, encrypting the first key using the device key comprises: deriving a symmetric encryption key using the device key; and encrypting the first key with the symmetric encryption key to generate the encrypted credential bundle.

In some embodiments of the method according to the first aspect of the present disclosure, before redirecting the user on the client device to perform the login to the identity provider, performing an enrollment process to register the client device with the web service provider as a trusted device for SSO for the user, the enrollment process comprising: generating a verifier using the second key; and sending the verifier to the web service provider for storage in association with the user and the client device for use in establishing the authenticated session for communication between the web service provider and the client device.

In some embodiments of the method according to the first aspect of the present disclosure, the client device is a first client device registered with the web service provider as a trusted device for the user, the method further comprising: receiving a notification from the web service provider indicating a second client device has requested to be registered with the web service provider as a trusted device for the user; establishing a shared secret with the second client device; and using the shared secret in a password authenticated key exchange (PAKE) with the second client device to establish a session key for end-to-end encrypted communication with the second client device via the web service provider, wherein neither the shared secret nor the session key is revealed to the web service provider; encrypting a copy of the credential bundle using the session key; and sending the encrypted copy of the credential bundle to the web service provider for retrieval by the second client device.

In some embodiments of the method according to the first aspect of the present disclosure, encrypting the copy of the credential bundle using the session key comprises: deriving a symmetric encryption key using the session key; and encrypting the copy of the credential bundle with the symmetric encryption key derived using the session key.

In some embodiments of the method according to the first aspect of the present disclosure: the shared secret comprises a code generated on the first client device; establishing the shared secret with the second client device comprises displaying the code on a display of the first client device with a prompt to enter the code on the second client device; and using the shared secret in the PAKE with the second client device comprises performing a PAKE handshake process with the second device via the web service provider using the code to establish the session key.

In some embodiments of the method according to the first aspect of the present disclosure, the PAKE is based on a balanced composable PAKE protocol.

A second aspect of the present disclosure provides a device. The device comprises: a user interface; one or more processors; memory; and one or more programs. The one or more programs are stored in the memory and configured to be executed by the one or more processors. The programs include: instructions for a computer-implemented method for facilitating SSO to a web service provider according to the first aspect of the present disclosure.

A third aspect of the present disclosure provides a computer readable storage medium. The computer readable storage medium has stored therein instructions, which when executed by a device cause the device to perform a computer-implemented method for facilitating SSO to a web service provider according to the first aspect of the present disclosure.

A fourth aspect of the present disclosure provides a computer-implemented method for facilitating passwordless sign-on to a web service provider. The method comprising: receiving, on a client device, user input to access a cryptographically protected resource provided by a web service provider; sending an authentication request to the web service provider to initiate an authentication process for a user on the client device to access the cryptographically protected resource; receiving, from the web service provider, a passkey challenge for the user; displaying a prompt on a display of the client device for the user to complete the passkey challenge with a passkey manager on the client device via user input on the client device; after the user completes the passkey challenge with the passkey manager to access a passkey stored on the client device and corresponding to an account of the user's with the web service provider, receiving, from the passkey manager, a passkey assertion generated by the passkey manager using the passkey corresponding to the user's account with the web service provider; sending the passkey assertion and a device identifier corresponding to the client device to the web service provider; after the web service provider confirms validity of the passkey assertion, receiving information conveying an encrypted credential bundle from the web service provider, the encrypted credential bundle corresponding to the user's account with the vault service provider and the client device, wherein the encrypted credential bundle is symmetrically encrypted using a device key previously generated on the client device and corresponding to the user's account with the web service provider and the client device, the encrypted credential bundle including at least an encrypted first key; retrieving, from local storage on the client device, the device key corresponding to the user's account with the web service provider and the client device; decrypting the encrypted credential bundle using the device key to obtain the first key; and using the first key to access the cryptographically protected resource provided by the web service provider.

In some embodiments of the method according to the fourth aspect of the present disclosure, the encrypted credential bundle further includes at least an encrypted second key, the method further comprising: decrypting the encrypted credential bundle using the device key to obtain the second key; and using the second key to establish an authorized session for communication between the web service provider and the client device.

In some embodiments of the method according to the fourth aspect of the present disclosure: the web service provider is a vault service provider; the cryptographically protected resource is a vault provided by the vault service provider; and using the first key to access the cryptographically protected resource provided by the web service provider comprises using the first key to decrypt an encrypted chain of keys to unlock the vault provided by the vault service provider.

In some embodiments of the method according to the fourth aspect of the present disclosure: the encrypted credential bundle is symmetrically encrypted with a symmetric encryption key derived from the device key; and decrypting the encrypted credential bundle using the device key comprises: i) deriving a symmetric decryption key using the device key; and ii) decrypting the encrypted credential bundle with the symmetric decryption key.

In some embodiments of the method according to the fourth aspect of the present disclosure, receiving the information conveying the encrypted credential bundle from the web service provider further comprises receiving information conveying user information and a sign-in token.

In some embodiments of the method according to the fourth aspect of the present disclosure, the passkey manager is part of an operating system running on the client device or part of a web browser running on the client device.

In some embodiments of the method according to the fourth aspect of the present disclosure further comprises: after the web service provider confirms validity of the passkey assertion, receiving information from the web service provider conveying a session identifier corresponding to an unverified session between the vault service provider and the client device, wherein using the second key to establish an authenticated session for communication with the vault service provider comprises using the second key to authenticate the unverified session corresponding to the session identifier received from the web service provider.

In some embodiments of the method according to the fourth aspect of the present disclosure, using the second key to establish an authenticated session for communication with the web service provider comprises using the second key in a password authenticated key exchange (PAKE) to establish the authenticated session for communication with the web service provider without revealing the first key to the web service provider.

In some embodiments of the method according to the fourth aspect of the present disclosure, using the second key in the PAKE to establish the authenticated session for communication with the web service provider comprises establishing a shared session key for end-to-end encrypted communication with the web service provider.

In some embodiments of the method according to the fourth aspect of the present disclosure, the PAKE is based on a secure remote password (SRP) protocol utilizing a verifier previously generated using the second key, wherein the verifier is stored on the web service provider.

In some embodiments of the method according to the fourth aspect of the present disclosure, before receiving the user input to access the cryptographically protected resource provided by the web service provider, performing an enrollment process to register the client device with the web service provider as a trusted device for passwordless sign-on for the user, the enrollment process comprising: generating the device key corresponding to the user's account with the vault service provider and the client device; generating the first key; encrypting the first key using the device key to generate the encrypted credential bundle; sending the encrypted credential bundle to the web service provider for storage in association with the user's account with the web service provider and the client device; receiving, on the client device, user input to register the client device with the web service provider as a trusted device for passwordless sign-on for the user; sending a passkey registration request to the web service provider to initiate a passkey registration process for the user's account with the web service provider, the passkey registration request including an account identifier corresponding to the user's account with the web service provider; receiving, from the web service provider, a passkey registration challenge for the user; displaying a prompt on a display of the client device for the user to complete the passkey registration challenge with the passkey manager on the client device via user input on the client device; after the user completes the passkey registration challenge with the passkey manager to create and store, on the client device, the passkey corresponding to the user's account with the web service provider, sending a public key credential corresponding to the passkey to the web service provider for use in confirming validity of passkey assertions generated using the passkey corresponding to the user's account with the web service provider.

In some embodiments of the method according to the fourth aspect of the present disclosure, encrypting the first key using the device key comprises: deriving a symmetric encryption key using the device key; and encrypting the first key with the symmetric encryption key to generate the encrypted credential bundle.

In some embodiments of the method according to the fourth aspect of the present disclosure, before receiving the user input to access the cryptographically protected resource provided by the web service provider, performing an enrollment process to register the client device with the web service provider as a trusted device for passwordless sign-on for the user, the enrollment process comprising: generating a verifier using the second key; and sending the verifier to the web service provider for storage in association with the user's account with the web service provider for use in establishing the authenticated session for communication between the web service provider and the client device.

In some embodiments of the method according to the fourth aspect of the present disclosure, the client device is a first client device registered with the web service provider as a trusted device for passwordless sign-on for the user, the method further comprising: receiving a notification from the web service provider indicating a second client device has requested to be registered with the web service provider as a trusted device for passwordless sign-on for the user; establishing a shared secret with the second client device; and using the shared secret in a password authenticated key exchange (PAKE) with the second client device to establish a session key for end-to-end encrypted communication with the second client device via the web service provider, wherein neither the shared secret nor the session key is revealed to the web service provider; encrypting a copy of the credential bundle using the session key; and sending the encrypted copy of the credential bundle to the web service provider for retrieval by the second client device.

In some embodiments of the method according to the fourth aspect of the present disclosure, encrypting the copy of the credential bundle using the session key comprises: deriving a symmetric encryption key using the session key; and encrypting the copy of the credential bundle with the symmetric encryption key derived using the session key.

In some embodiments of the method according to the fourth aspect of the present disclosure: the shared secret comprises a code generated on the first client device; establishing the shared secret with the second client device comprises displaying the code on a display of the first client device with a prompt to enter the code on the second client device; and using the shared secret in the PAKE with the second client device comprises performing a PAKE handshake process with the second device via the web service provider using the code to establish the session key.

In some embodiments of the method according to the fourth aspect of the present disclosure, the PAKE is based on a balanced composable PAKE protocol.

A fifth aspect of the present disclosure provides a device. The device comprises: a user interface; one or more processors; memory; and one or more programs. The one or more programs are stored in the memory and configured to be executed by the one or more processors. The programs include: instructions for a computer-implemented method for facilitating passwordless sign-on to a web service provider according to the fourth aspect of the present disclosure.

A sixth aspect of the present disclosure provides a computer readable storage medium. The computer readable storage medium has stored therein instructions, which when executed by a device cause the device to perform a computer-implemented method for facilitating passwordless sign-on to a web service provider according to the fourth aspect of the present disclosure.

Other aspects and features of embodiments of the present disclosure will become apparent to those ordinarily skilled in the art upon review of the following description.

### BRIEF DESCRIPTION OF THE DRAWINGS

Reference will now be made, by way of example, to the accompanying drawings which show example embodiments of the present application, and in which:

FIG. 1A is a flow diagram illustrating a conventional SSO sign-in flow involving a user, a web service provider and an identity provider;

FIG. 1B is a flow diagram illustrating a SSO sign-in flow involving a user, a vault service provider and an identity provider, according to an embodiment of the present disclosure;

FIG. 2A is a block diagram of an example implementation of a system for authenticating a user and decrypting stored data in a zero-knowledge architecture that supports single sign-on and/or passwordless sign-on, according to an embodiment of the present disclosure;

FIG. 2B is a block diagram of an example implementation of the system depicted in FIG. 2A that includes examples of data elements that may be stored on the various components of the system, according to an embodiment of the present disclosure;

FIGS. 3A, 3B and 3C are flow diagrams illustrating example operations of a method for single sign-on to a vault provided by a vault service provider, according to an embodiment of the present disclosure;

FIG. 3D is a flow diagrams illustrating example operations for enrolling a new client device as the initial trusted client device for a user for single sign-on to the vault provided by the vault service provider in the context of the method in FIGS. 3A, 3B and 3C, according to an embodiment of the present disclosure;

FIGS. 3E and 3F are flow diagrams illustrating example operations for enrolling a new client device as a trusted client device for a user for single sign-on to the vault provided by the vault service provider in the context of the method in FIGS. 3A, 3B and 3C using an existing trusted client device as a verifying device, according to an embodiment of the present disclosure;

FIG. 4 is a message flow diagram illustrating example operations of a method for enrolling a new client device as a trusted client device for single sign-on using an existing trusted client device as a verifying client device according to an embodiment of the present disclosure;

FIG. 5 is a message flow diagram illustrating example operations of a method for unlocking a vault on a trusted client device using biometrics according to an embodiment of the present disclosure;

FIG. 6 is a message flow diagram illustrating example operations of a method for passwordless sign-on to a vault provided by a vault service provider according to an embodiment of the present disclosure; and

FIG. 7 is a message flow diagram illustrating operations of a method for enrolling a new client device as a trusted client device for passwordless sign-on using an existing trusted client device as a verifying client device according to an embodiment of the present disclosure.

Similar reference numerals may have been used in different figures to denote similar components.

In the drawings, embodiments are illustrated by way of example. It is to be expressly understood that the description and drawings are only for purposes of illustrating certain embodiments and are an aid for understanding. They are not intended to be a definition of the limits of the invention.

### DESCRIPTION OF EXAMPLE EMBODIMENTS

The present disclosure is made with reference to the accompanying drawings, in which certain non-limiting embodiments are shown. However, the description should not be construed as being limited to the embodiments set forth herein. Rather, these embodiments are provided as examples. Like numbers refer to like elements/components throughout. Separate boxes or illustrated separation of functional elements or modules of illustrated systems and devices does not necessarily require physical separation of such functions or modules, as communication between such elements can occur by way of messaging, function calls, shared memory space, and so on, without any such physical separation. As such, functions or modules need not be implemented in physically or logically separated platforms, although they may be illustrated separately for ease of explanation herein. Different devices can have different designs, such that while some devices implement some functions in fixed function hardware, other devices can implement such functions in a programmable processor with code obtained from a machine readable medium.

Single Sign-On (SSO) is the term used for when someone—in the setting of a company or another organization-provides a user with a single set of credentials (e.g., username, password or other authentication factors) to log in to services that company or organization provides for the user. SSO procedures allow a user to sign-in to, or at least access, one or more service providers or other resources that require login procedures by performing a single login procedure.

SSO typically involves transferring identity data between two parties, namely an identity provider (IdP) and a service provider (SP). Many known identity providers are widely used, such as, for example, Azure Active Directory, Duo, JumpCloud, Okta, OneLogin, Ping, and others. When a user signs in with SSO to access a requested resource, they sign in with the credentials required by the identity provider instead of using the service provider-specific account credentials that would otherwise allow the user to authenticate directly with the service provider in order to access the requested resource. The identity provider performs authentication and passes the user's identity and proof of authorization to the user. The user uses the proof of authorization from the identity provider to sign-in to the service provider. The service provider trust the identity provider and authorizes the user to access the requested resource based on the proof of authorization provided by the identity provider.

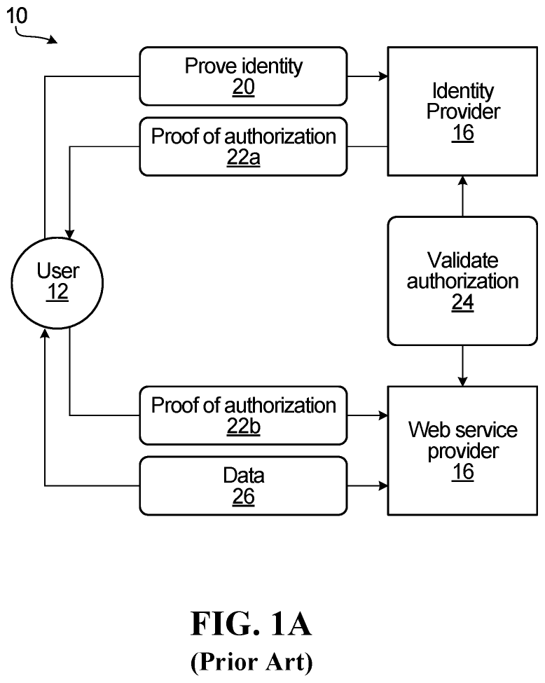

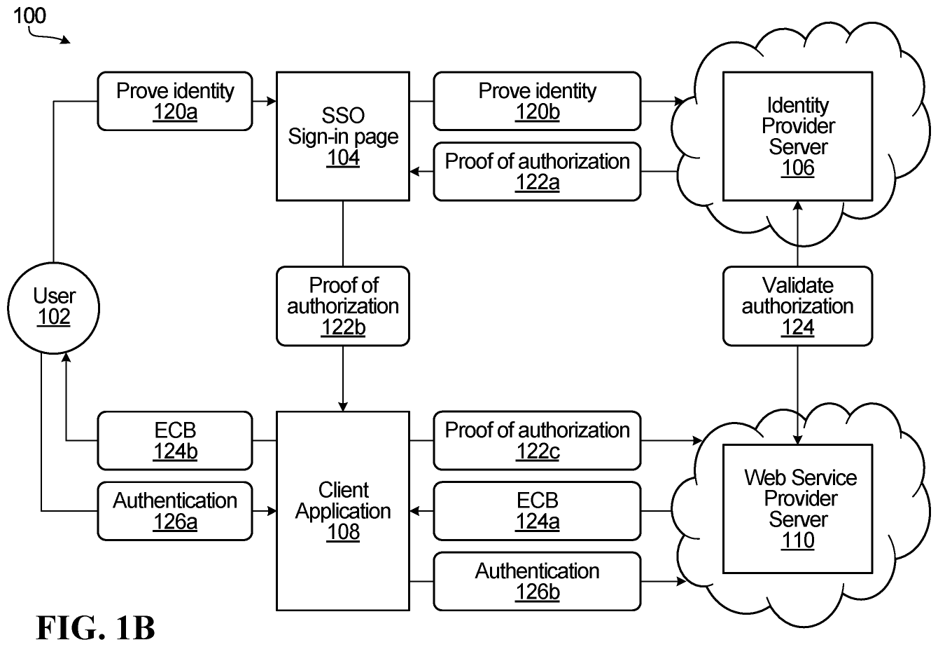

FIG. 1A depicts an example of a conventional SSO sign-in flow 10 involving a user 12, a web service provider 14 and an identity provider 16. It is noted that the example SSO sign-in flow 10 depicted in FIG. 1A is based on the OIDC SSO authorization flow. For some identity providers, the destinations of certain arrows shown in FIG. 1A may be different depending on the particular SSO standard supported by the identity provider. The SSO sign-in flow 10 begins with user 12 providing the required credentials to sign-in to identity provider 16 in order to provide proof of the user's identity to identity provider 16, as indicated at 20. Identity provider 16 performs authentication based on the provided sign-in credentials and, if the authentication is successful, provides proof of authorization to user 12, as indicated at 22a. User 12 provides the proof of authorization from identity provider 16 to web service 14, as indicated at 22b. Web service provider 14 performs a validation of the proof of authorization with identity provider 16, as indicated at 24. If the validation is successful, web service provider 14 provides access to the requested resource to user 12, as indicated at 26.

Most web services “just” need to solve authentication and authorization problems—i.e. determining whether a user is who they say they are, and whether they should have access to a resource. For these kinds of services, SSO is an attractive solution for organizations because it provides centralized management of what users can access, and allows enforcement of strong authentication, policy, and auditability.

Some web service providers, such as vault service providers that provide digital vaults for the secure maintenance of user data, may be configured to provide a “zero-knowledge” service utilizing zero-knowledge end-to-end (E2E) encryption. In encryption, zero-knowledge means that data is secured with a unique user key, which the web service provider does not know. With zero-knowledge encryption, no one but the user that possesses the user key can access their encrypted files. In such cases, the unique user key may be generated by the user based on the web-service specific account credentials (e.g., a user's vault service account password) that would otherwise allow the user to authenticate directly with the service provider. However, as noted earlier, when signing-in via SSO, a user signs in with the credentials required by the identity provider rather than service provider-specific account credentials. As such, the user may not have service provider-specific account credentials, and therefore would be unable to generate the unique user key based on web-service specific account credentials. For example, referring again to FIG. 1A, if the data exchanged at 26 between user 12 and web service provider 16 is encrypted with a unique user key based on service provider-specific account credentials, and user 12 does not have service provider-specific account credentials that allow user 12 to generate the unique user key, then user 12 is unable to decrypt the encrypted data.

Traditional SSO is not made to solve this decryption problem. Popular protocols used for signing in with SSO-Open Authorization (OAuth), OpenID Connect (OIDC), Security Assertion Markup Language (SAML)—do not provide a way for the user to end up with a decryption key for end-to-end encryption only the user knows, i.e., a decryption key that the service provider does not also know.

A similar problem exists with known passwordless sign-on procedures that utilize passkeys. A passkey is a digital credential, tied to a user account and a web service or application. Passkeys can allow a user to authenticate without having to enter a username or password, or provide any additional authentication factor. This technology aims to replace legacy authentication mechanisms such as passwords. Passkeys use public key cryptography. When a user creates a passkey with a web service provider or application, this generates a public-private key pair on the user's device. Only the public key is provided to and stored by the web service provider or application. When a user wants to sign-on to a service that uses passkeys, their browser or operating system will help them select and use the right passkey. To make sure only the rightful owner can use a passkey, the browser or operating system will prompt the user to unlock their device. This may be performed with a biometric sensor (such as a fingerprint or facial recognition), PIN, or pattern. Successfully unlocking the device provides access to the user's passkey and the user's device generates a signature based on the private key portion of the passkey. This signature is sent to the web service or application and is verified using the public key portion of the passkey. Because passkeys are bound to a web service or application's identity, they are safe from phishing attacks. The browser and/or operating system of the user's device ensure that a passkey can only be used with the web service or application for which they were created. An attacker cannot derive the user's private key from the data stored on the web service provider's server(s), which is required to complete authentication.

However, although a passkey provides a user with a unique private key for authentication with a corresponding web service or application, conventional passwordless sign-on using passkeys does not solve the decryption problem described above because it does not provide a way for the user to end up with a decryption key only the user knows that can be used for end-to-end encryption between the user and the web service or application.

Aspects of the present disclosure provide improved methods and systems for facilitating single sign-on and passwordless sign-on to web services in a manner that supports end-to-end encryption in a zero-knowledge environment.

The following describes systems and methods for single sign-on (SSO) authentication and passwordless authentication to sign-on to a web service provider in a zero-knowledge environment. The web service may be a vault service provider implemented as a cloud server, for example. The SSO authentication techniques disclosed herein may be adapted to work with any IdP, such as Azure Active Directory, Duo, JumpCloud, Okta, OneLogin, Ping, and others. The web service provider may store sensitive user data that is only ever transported in encrypted form and can only be decrypted for use on a user's client device that has access to the keys necessary to decrypt the encrypted form of the data. A zero-knowledge environment is preserved because the web service provider does not have access to the keys necessary to decrypt the encrypted form of the data.

In example implementations, a symmetric cryptographic key, which is referred to herein as a device key, is generated and stored on a client device that is configured for single sign-on or passwordless sign-on to access a cryptographically protected resource provided by a web service provider, such as a vault provided by a vault service provider. The symmetric device key is used to decrypt a symmetrically encrypted credential bundle that is received from the web service provider upon successful sign-on. As discussed in further detail below, in some embodiments the credential bundle may include at least a first key for accessing the cryptographically protected resource provided by the web service provider. For example, in some embodiments the credential bundle may include key(s) necessary to establish an authenticated/secure session with the web service provider and/or to decrypt an encrypted chain of keys to unlock the cryptographically protected resource (e.g., to unlock the vault provided by a vault service provider).

Before discussing the foregoing aspects of the present disclosure in further detail, an illustrative example will first be described with reference to FIG. 1B in order to provide an illustrative example of how aspects of the present disclosure address the decryption problem discussed above with reference to FIG. 1A, which conventional SSO processes and passwordless sign-on processes are not designed to address.

FIG. 1B is a flow diagram illustrating a SSO sign-in flow 100 involving a user, a SSO sign-in page 104, a cloud-based identity provider 106 and a client application 108 for a cloud-based web service provider server 110, according to an embodiment of the present disclosure. For example, as discussed in further detail below, in some embodiments the web service provider server 110 may be a cloud server for a vault service provider.

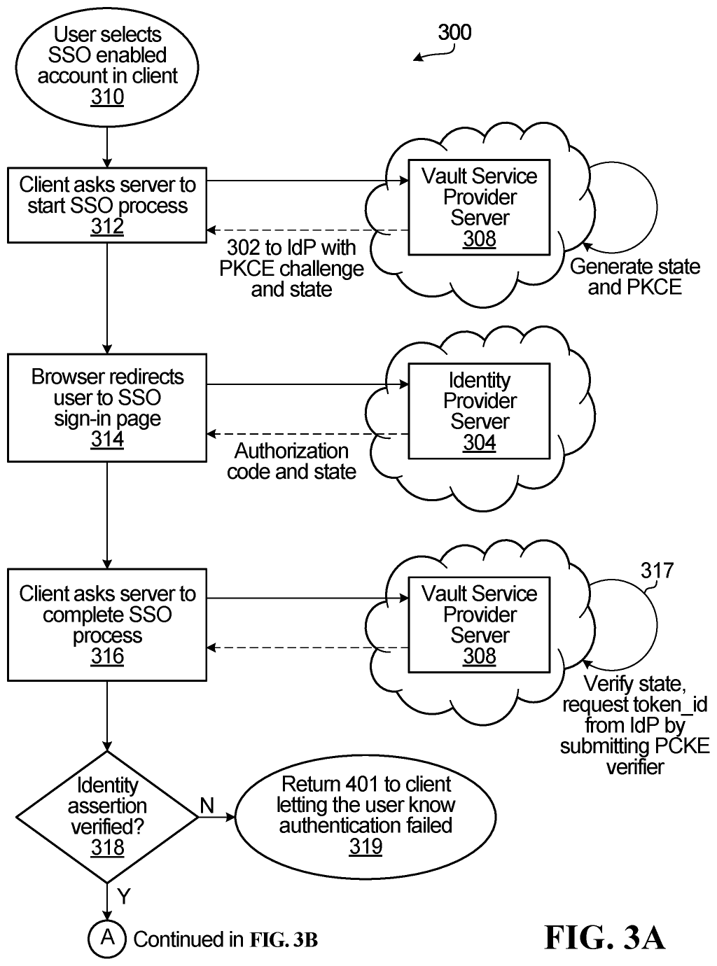

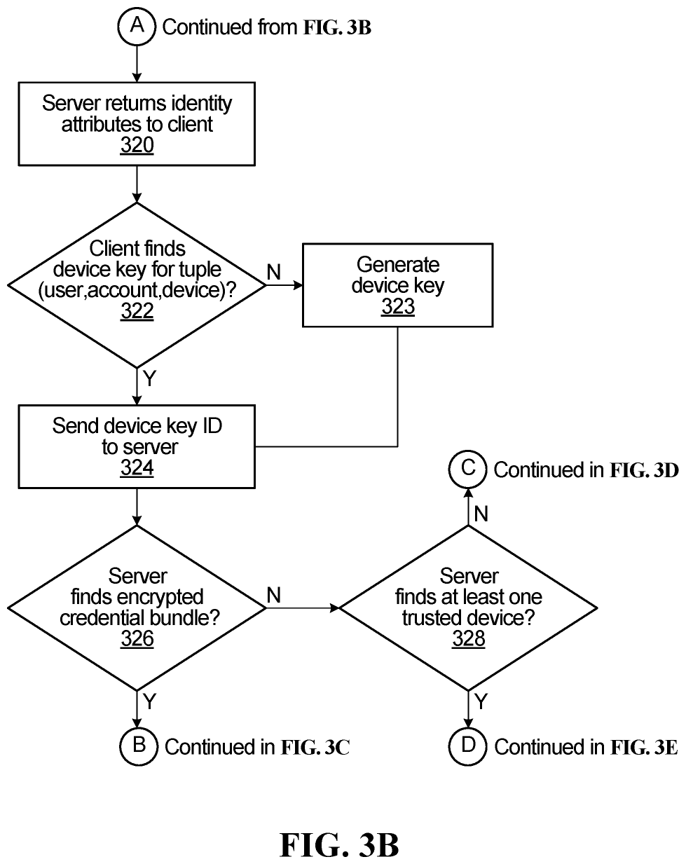

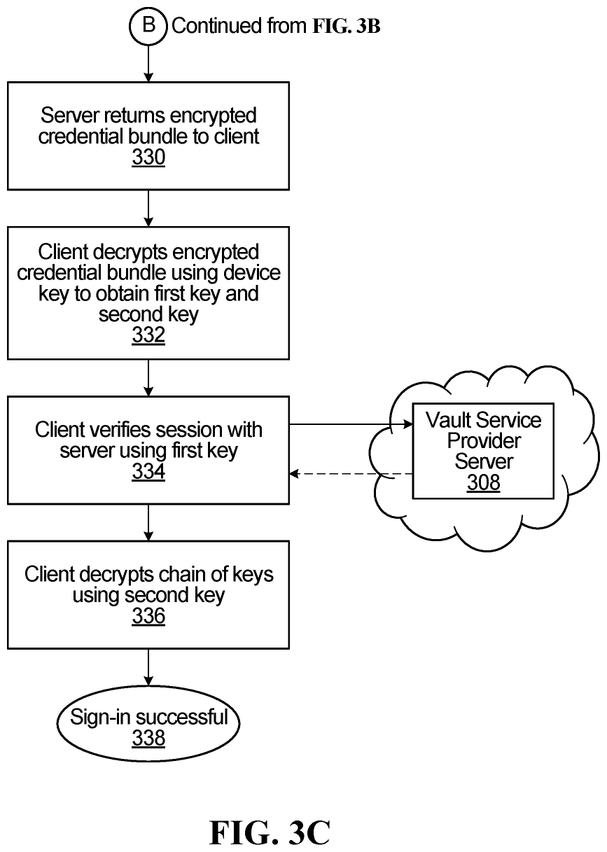

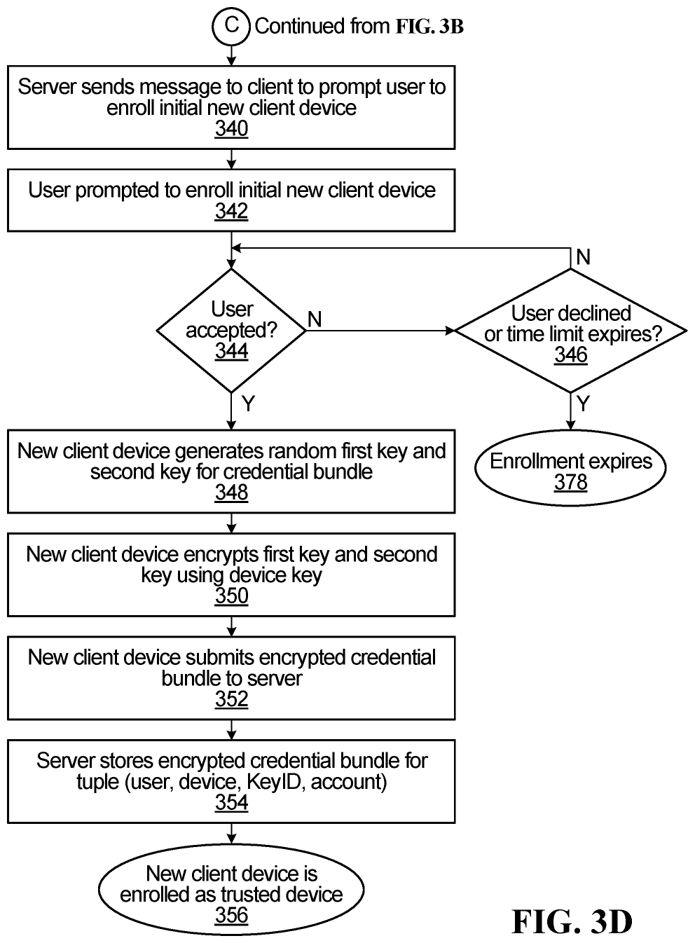

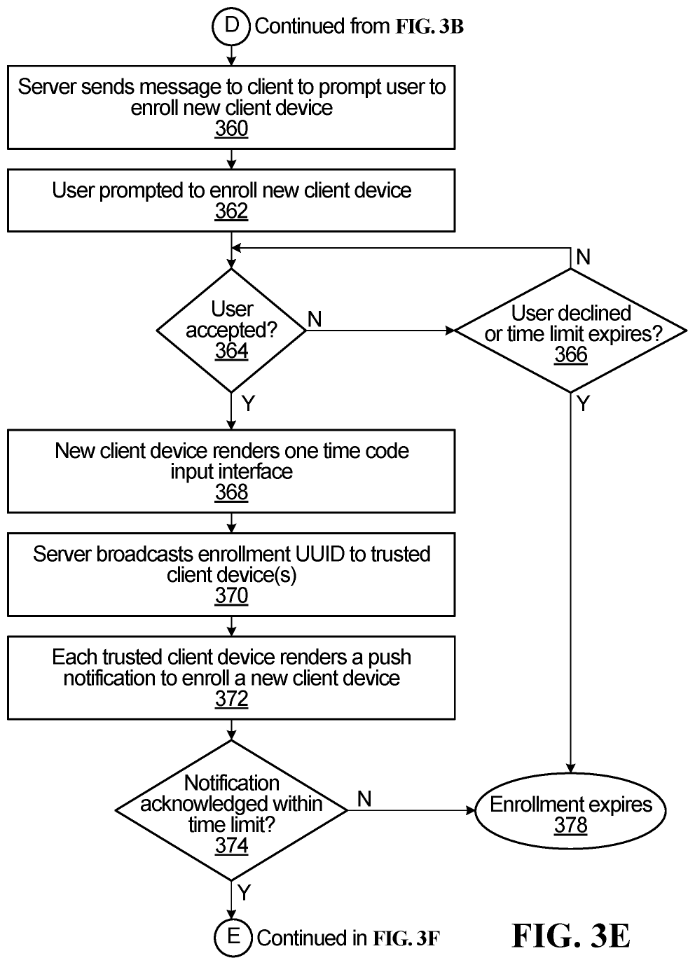

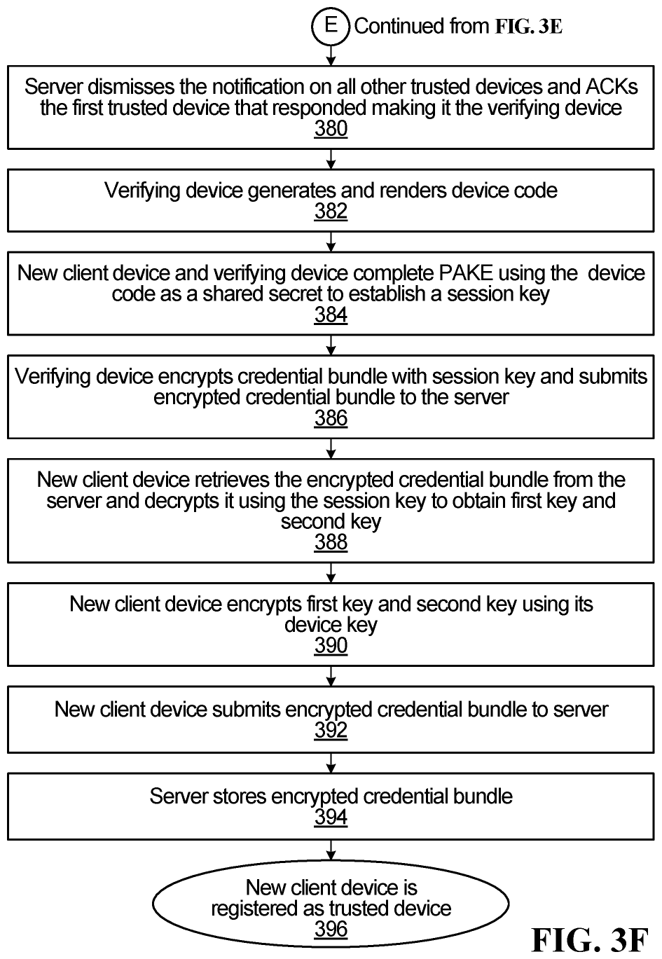

User 102 may launch or start the client application 108 for the web service provider on a client device. The client application 108 may be a program the user may download, e.g., from the web service provider or an online application store, such as the Apple App Store or Google Play Store. The client application 108 may also or instead be implemented as a webpage having a sign-on interface to establish a session with the web service provider server 110. For example, the client application 108 may provide the user 102 with a user interface to access a vault or some other cryptographically protected resource associated with the user on the web service provider server 110. For example, when the user 102 opens a lock screen for the client application 108, the client application may render a user interface that prompts the user to select an account to sign in to the web service provider. Once the user selects an account, the client application 108 may inquire with the web service provider server 110 what authentication methods are available for the given account. For example, the web service provider 110 may map the request context to existing sign-on settings for the given account to determine whether to allow regular authentication via an account password, via SSO authentication and/or via passwordless authentication. For the purposes of this example, it is assumed that the account selected by the user 102 is authorized for at least SSO authentication, and therefore the client application 108 may render a user interface that includes a user-selectable SSO button that is selectable by the user to initiate an SSO sign-in process. Clicking on it will request the web service provider server 110 to generate the attributes needed to initiate the SSO flow with the identity provider server 106. A more detailed discussion of a SSO sign-in flow is provided below with reference to FIGS. 3A-3F. For the purposes of the example shown in FIG. 1B, it is assumed that the SSO flow has been initiated and the user has been redirected to SSO sign-in page 104 to provide proof of identity, as indicated at 120a. The proof of identity provided by user 102 at 120a is the user's SSO sign-in credentials, which may include a username and password. In some implementations, the identity provider may require two-factor authentication, such as recording a user's fingerprint or other biometric data, entering a code received at a user's email address or phone number after acceptance of the user's password, and/or other mechanisms for two-factor authentication. The SSO sign-in page 104 forwards the proof of identity to the identity provider server 106, as indicated at 120b. The identity provider server 106 performs authentication based on the provided proof of identity and, if the authentication is successful, provides proof of authorization to the web service provider 110 via the SSO sign-in page 104 and the client application 108, as indicated at 122a, 122b and 122c. The web service provider server 110 performs a validation of the proof of authorization with identity provider 16. For example, in some implementations, the web service provider server 110 may verify that a state attribute in the proof of authorization provided by the identity provider server 106 matches the original state value in a uniform resource identifier (URI) that was part of an HTTP redirect generated by the web service provider server 110 to redirect the user 102 to the SSO sign-on page 104. In some implementations, if the verification is successful, the web service provider server 110 completes the SSO sign-in process by requesting an identity assertion directly from the identity provider server 106 without needing to pass through the client application 108 or the browser rendering the SSO sign-in page 104, as indicated at 124.

With the SSO authentication successfully completed, the web service provider 110 sends an encrypted credential bundle (ECB) to the user 102 via client application 108, as indicated at 124a and 124b. The encrypted credential bundle corresponds to the user 102 and the client device on which the client application 108 is operated and is symmetrically encrypted using a device key that was previously generated on the client device on which the client application 108 is operated. The encrypted credential bundle includes at least an encrypted first key. The user 102 may then retrieve, from local storage on the client device, the previously generated device key corresponding to the user's account with the vault service provider and the client device, and decrypt the encrypted credential bundle using the device key to obtain the first key. As described in further detail below under the headings Encrypting a Credential Bundle and Decrypting an Encrypted Credential Bundle, in some embodiments, using a device key to encrypt a credential bundle and decrypt an encrypted credential bundle involves using the device key as input key material (IKM) to a key derivation function to derive symmetric encryption/decryption key(s) that are then used to encrypt the credential bundle and decrypt the encrypted credential bundle.

After the encrypted credential bundle has been decrypted to obtain the first key, the user 102 may then use the first key to access a cryptographically protected resource provided by the web service provider. For example, in some embodiments the web service provider may be a vault service provider used to securely store data for user 102, such as data that may be used to connect to or access other associated resources. For example, such data could include encryption and decryption keys needed for the other associated resources, passwords, two-factor authentication data, and any other data the user 102 wishes to maintain in a secure and accessible manner. In such embodiments, the user 102 may use the first key in the credential bundle to decrypt an encrypted chain of keys to unlock the vault associated with the user's account with the vault service provider. For example, as will be discussed in further detail later on, the encrypted chain of keys may include a vault key and an account private key that is the private part of an account key pair corresponding to the user's account with the vault service provider. Data elements in the user's vault may be encrypted and decrypted with the vault key. The vault key may be encrypted with the account public key that is the public part of the account key pair corresponding to the user's account with the vault service provider. The account private key may be encrypted with the first key in the credential bundle (or another key derived from the first key). In such implementations, decrypting the account private key with the first key makes it possible to decrypt the vault key, which was encrypted with the account public key, and therefore effectively unlocks the vault by allowing data elements to be encrypted and decrypted with the decrypted vault key. As such, the first key in the credential bundle may also be referred to as an account unlock key (AUK). In such embodiments, the encrypted data key and the data encryption key are stored in a zero-knowledge environment such that the vault service provider does not have access to the unencrypted vault key, the unencrypted credential bundle, the account private key or the device key.

In some embodiments, the encrypted credential bundle may further include an encrypted second key. In such embodiments, after the encrypted credential bundle has been decrypted to obtain the first key and the second key, the user 102 may then use the second key to establish an authenticated session for communication with the web service provider server 110 via the client application 108, as indicated at 126a and 126b. As such, the second key in the credential bundle may also be referred to as a session authentication key (SAK). For example, the second key may be used in a password authenticated key exchange (PAKE) to establish a shared session key for end-to-end encrypted communication with the web service provider server 110 without revealing the second key to the web service provider server. In some implementations, the PAKE used to establish the shared session key with the web service provider server 110 may be based on the secure remote password (SRP) protocol described in Taylor, D. et al. Using the Secure Remote Password (SRP) Protocol for TLS Authentication. RFC 5054 (Informational), Internet Engineering Task Force, November 2007; URL: http://www.ietf.org/rfc/rfc5054.txt (hereinafter referred to as “RFC 5054”) and Wu, T. The SRP Authentication and Key Exchange System. RFC 2945 (Proposed Standard). Internet Engineering Task Force, September 2000; URL: http://www.ietf.org/rfc/rfc2945.txt (hereinafter referred to as “RFC 2945”), as discussed in further herein with reference to FIG. 3C.

In some embodiments, the credential bundle of the user 102 is not stored permanently anywhere. However, the encrypted version of the credential bundle may be stored on the web service provider server 110 in association with a user identifier (ID) associated with the user and a device ID associated with the client device on which the client application 108 is operated. When the user 102 first configures SSO authentication access to the web service provider, or runs the client application 108 for the first time, the client application 108 may generate the device key described earlier. The device key may be any suitable symmetric key such as, for example, a 256-bit key used in an Advanced Encryption Standard with Galois Counter Mode (AES-GCM) scheme or similar schemes. As discussed in further detail herein with reference to FIG. 3D, if the web service provider server 110 does not have an encrypted credential bundle associated with the user 102 and the client device on which the client application 108 is running, the client application 108 may randomly generate the key(s) for the credential bundle, e.g., the first key and the second key, and encrypt the key(s) using the device key to generate the encrypted credential bundle. The client application 108 may then send the encrypted credential bundle to the web service provider server 110 to be stored in association with the user and the client device on which the client application 108 is operated (i.e., the client device on which the device key was generated and on which the device key is stored for use in decrypting the corresponding encrypted credential bundle encrypted using the device key). The encrypted credential bundle may then be retrieved by the client application 108 from the web service provider server 110 during subsequent sign-on authentications, as indicated at 126. After the web service provider server stores the encrypted credential bundle in association with the user 102 and the client device on which the client application 108 is operated, the client device is considered to be enrolled as a trusted client device for SSO authenticated access for the user.

In some embodiments, the client application 108 may also send a key identifier (ID) corresponding to the device key to the web service provider server 110 to be used as an identifier for the device key (i.e., to be used to identify the device key used for the symmetric encryption of the credential bundle).

In some embodiments, the encrypted credential bundle may be stored by the web service provider server 110 in association with the user, the client device, a particular account of the user and the key ID corresponding to the device key that was used to encrypt the credential bundle (e.g., the encrypted credential bundle may be stored in associated with the tuple (user ID, device ID, account ID, key ID)). Associating the encrypted credential bundle with a specific account ID can be advantageous because a user may have multiple accounts registered in a client device and it may be desirable to avoid permitting the user to reuse the same key pairs across multiple accounts in order to reduce the surface area affected by leaked credentials. In practice, the probability of two client devices of the same user and account generating the same key ID is negligible but non-zero. This is why also including the device ID in the tuple for uniquely identifying the encrypted credential bundle can be advantageous, because it can prevent an unenrolled device with the same user ID, account ID and key ID from automatically becoming a trusted device.

Although the example described above with reference to FIG. 1B is in the context of SSO authenticated access to a web service provider, it is noted that the techniques disclosed herein are also applicable to facilitating secure passwordless sign-on to a web service provider.

After the user's first client device is enrolled as a trusted client device, the user may have other devices on which the user may wish to access the web service provider. Once at least one client device has been enrolled as a trusted client device for SSO or passwordless sign-on for the user, the user may register additional client devices by using a previously enrolled trusted client device as a verifying client device. Example implementations of enrolling additional client devices as trusted devices for SSO or passwordless sign-on after at least one client device has already been enrolled as a trusted device are described below with reference to FIGS. 3E, 3F, 4 and 7.

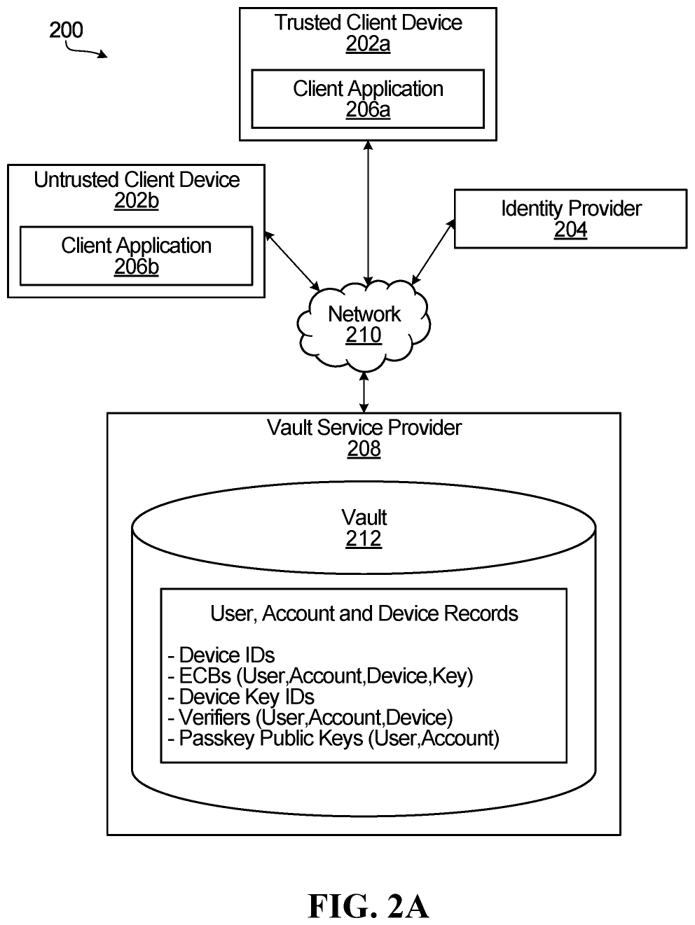

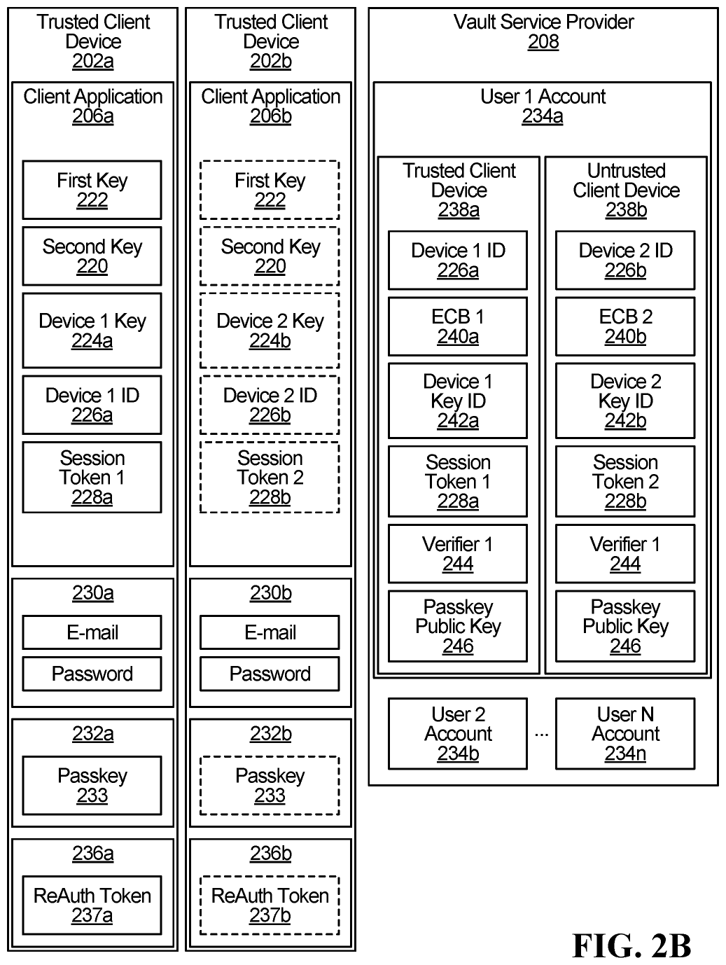

FIG. 2A is a block diagram of an example implementation of a system for authenticating a user and decrypting stored data in a zero-knowledge architecture that supports single sign-on and/or passwordless sign-on, according to an embodiment of the present disclosure. FIG. 2B is a block diagram of an example implementation of the system 200 that includes examples of data elements that may be stored on the various components of the system. The system 200 includes a network 100, which can include a public data network such as the internet, a first trusted client device 202a, a second untrusted client device 202b, an identity provider 204, and a web service provider, which in this example is a vault service provider 208 that provides storage for a data vault 212. The vault 212 may be used to store, for example, sensitive data belonging to users having a user account with the vault service provider 208.

The client devices 202a and 202b may be client devices that are used by a user to access internet resources. Users may have a smartphone, a tablet, a laptop, a desktop, a smart watch, and/or other similar devices that are able to access the Internet. In this description, a client device may include a browser on a computing device. The first client device 202a may be enrolled as a trusted client device associated with the user (as discussed above and described in further detail below with reference to FIGS. 3D-3F). A client device must be enrolled as a trusted client device for SSO and/or passwordless sign-on of a user to the vault service provider 208 before it can be used by the user for that purpose. An untrusted client device, such as the untrusted client device 202b may be one that is associated with the user, but has not yet generated a device key and had a corresponding encrypted credential bundle (encrypted using the device key) uploaded to the vault service provider 208. When the encrypted credential bundle corresponding to the trusted client device 202a has been decrypted on the trusted client device 202a using its locally stored device key, the second key obtained from the decrypted credential bundle may be used to establish an authenticated session for communication with the vault service provider server and the first key obtained from the credential bundle may be used to decrypt an encrypted chain of keys to unlock the vault associated with the user's account with the vault service provider 208. For example, as discussed earlier, in some embodiments an encrypted account private key may be decrypted with the first key (or another key derived therefrom) and the decrypted account private key may be used to decrypt an encrypted vault key encrypted with a corresponding account public key. The decrypted vault key may then be used to decrypt sensitive data stored locally on trusted client device 202a, decrypt data received from the user's vault 212 via the vault service provider 208, and encrypt data to be sent to the vault 212 via the vault service provider 208.

In the example depicted in FIGS. 2A and 2B, the client device 202a and 202b each have a client application 206a and 206b installed thereon. The client applications 206a and 206b may be download and installed on the respective client device 202a and 202b or instead may be implemented as a webpage having a sign-on interface to establish a session with the vault service provider 208. For example, each client application 206 may provide the user with a user interface to access the vault 212 associated with the user on the vault service provider 208. For example, when the user opens the client application 206, the client application may render a user interface that prompts the user to select an account to sign-on to the vault service provider 208. Once the user selects an account, the client application 206 may inquire with the vault service provider server 110 what authentication methods are available for the given account. For example, the vault service provider 110 may map the request context to existing sign-on settings for the given account to determine whether to allow regular authentication via an account password, via SSO authentication and/or via passwordless authentication.

In example implementations, the client device 202a that is enrolled first by the user may allow for other client devices to be enrolled as trusted devices. Enrolling untrusted client devices, such as the untrusted client device 202b depicted in FIGS. 2A and 2B involves using an existing trusted client device, such as the trusted client device 202a depicted in FIGS. 2A and 2B, as a “verifying” client device.

The use of an existing trusted client device as a verifying client device is described in further detail below with reference to FIGS. 3E, 3F, 4 and 7. A verifying client device may be any client device that has been enrolled as a trusted client device. In some implementations, the first client device enrolled as a trusted client device for a user automatically becomes a verifying device for verifying the enrollment of new client devices as trusted client devices for the user.

The identity provider 204 in FIG. 2A may facilitate SSO to the vault service provider in the same or similar way as the identity provider server 106 described earlier with reference to FIG. 1B. The identity provider 204 (FIG. 1A) may be configured for use by a plurality of users, and therefore may include account information for each user.

The vault service provider 208 may include user profiles or accounts created for each user. A user's profile or account may include:
device identifiers of client devices that the user may have enrolled;
encrypted credential bundles and corresponding key IDs for the device keys used to encrypt the credential bundles;
verifiers for use in establishing authenticated sessions between the vault service provider 208 and respective trusted client devices, as will be discussed in further detail below with reference to FIG. 3C; and
passkey public keys for users that have enrolled at least one client device as a trusted client device for passwordless sign-on and generated a passkey for that purpose.

As noted earlier, a user may have multiple accounts with the vault service provider 208 and each account for a given user may have a corresponding credential bundle and chain of keys to avoid permitting the user to reuse the same keys across multiple accounts.

FIG. 2B depicts one example implementation of the secure SSO system 200 in FIG. 2A. The block diagram in FIG. 2B depicts an environment of the system 200 in FIG. 2A in which a user uses the first trusted client device 202a and the untrusted client device 202b.

As shown in FIG. 2B, if the trusted client device 202a has been enrolled as a trusted client device for SSO via identity provider 204 and/or passwordless sign-on access to the vault service provider 208, the trusted client device 202a may include security data that allows the user to access the user's vault 212 provided by the vault service provider 208. The security data may include, for example, the second key 220 (i.e., the SAK), the first key 222 (i.e., the AUK), a device key 224a, a device identifier 226a, and a session token 228a.

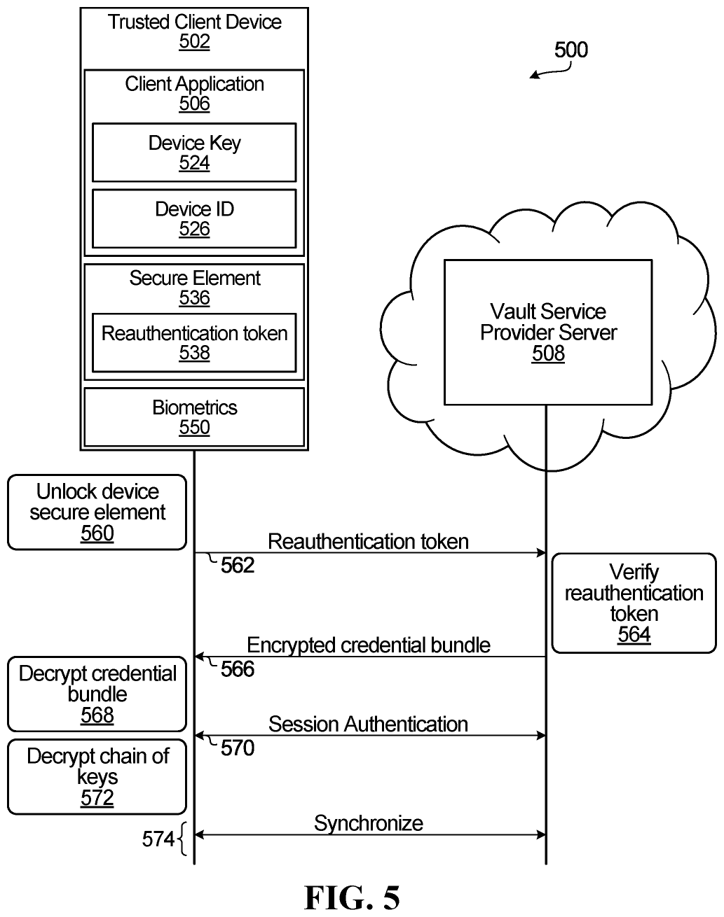

As also shown in FIG. 2B, if the trusted client device 202a has been enrolled as a trusted client device for SSO access to the vault service provider 208 via identity provider 204, the trusted client device 202a may include identity provider login information 230a, which may include an e-mail address and a password used by the identity provider 204 to confirm the user's identity for SSO. As described in further detail below with reference to FIG. 5, if the trusted client device 202a has successfully signed-on to the vault service provider 208 via SSO, the trusted client device 202a may also have a reauthentication token 237a stored thereon in a secure element 236a that is unlockable via biometrics. In such implementations, the second key 220 and the first key 222 may also be securely stored on the trusted client device 202a and made accessible along with the reauthentication token 238a via biometrics unlock.

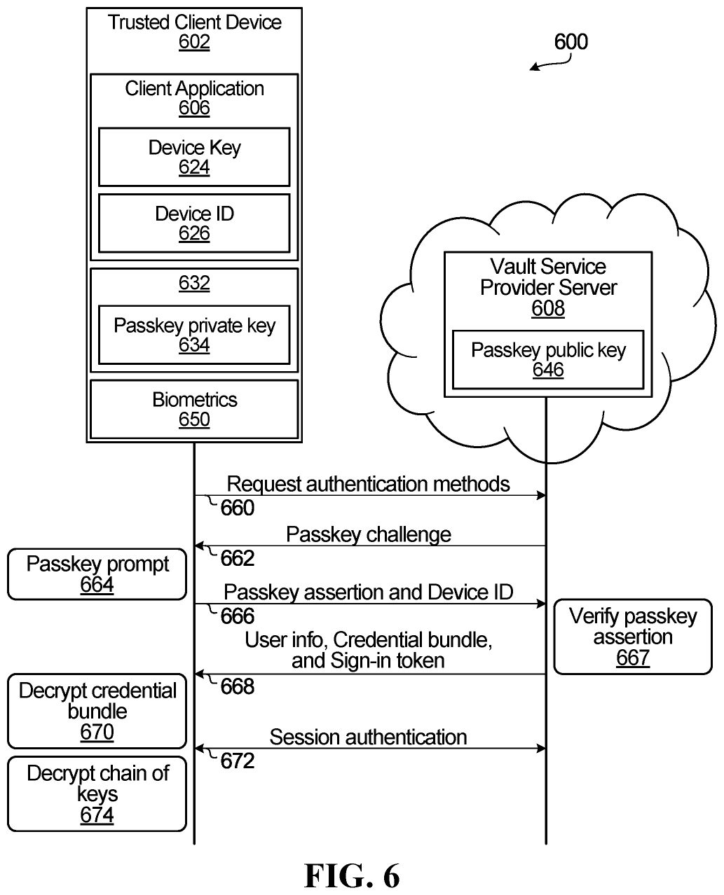

In addition, or instead, if the trusted client device 202a has been enrolled as a trusted client device for passwordless sign-on access to the vault service provider 208, the trusted client device 202a may include a passkey 233 stored in a secure data element 232a for use in accessing passwordless sign-on to the vault service provider 208, as described in further detail below with reference to FIG. 6.

In this example, it is assumed that the trusted client device 202a in FIG. 2B has already been enrolled by the user with the vault service provider 208 as a trusted client device for SSO and/or passwordless sign-on access to the vault service provider 208. As such, the trusted client device 202a is shown as having already generated and stored a device 1 key 224a and a key ID corresponding to the device 1 key 224a is stored in a trusted client device data storage 238a by the vault service provider 208. The trusted client device 202a stores a session 1 token 228a and a device identifier 1 226a received from the vault service provider 208 during the enrollment process. The session token 1 226a may be used by the trusted client device 202a in communications between the trusted client device 202a and the vault service provider 208. The device 1 identifier 226a is used to identify the client device 202a as a trusted client device for the user. The device 1 identifier 226a may be stored in the vault service provider 208 and/or the client device 202a local storage.

The trusted client device 202a in FIG. 2B receives an encrypted credential bundle 240a stored in the vault service provider 208 when the user successfully signs-on to the vault service provider 208 (e.g. via SSO or passwordless sign-on), and decrypts the encrypted credential bundle 240a using the device 1 key 224a that is stored only in local storage on the client device 202a. Decryption of the encrypted credential bundle generates the second key 220 and the first key 222 for the user. The second key 220 is then available on the client device 202a for use in conjunction with the corresponding verifier 244 on the vault service provider 208 to establish an authenticated session with the vault service provider 208, as will be described in further detail below with reference to FIG. 3C. Similarly, the first key is available to decrypt the chain of keys needed to decrypt and encrypt the user's data that is secured by the vault service provider 208. The second key 220 and the first key 222 are not permanently maintained in the trusted client device 202a. For example, in some implementations, once the user shuts down a session in which the first key 220 and the first key 222 are used, the second key 220 and the first key 222 may be deleted.

The vault service provider 208 stores information about the user in a user account data storage. The example in FIG. 2B illustrates storage for multiple users, namely a user 1 account 234a, a user 2 account 234b through to a user N account 234n. It is noted that this example arrangement of user account information is merely provided as one example of a way data may be structured in an example system.

As shown in FIG. 2B, in some implementations the vault service provider 208 may organize the user's data according to client device. For example, in the illustrated example, the user's data for the trusted client device 202a may be stored in the vault service provider 208 in the trusted client device data storage 238a. The secure data shown stored in the trusted client device data storage 238a includes the device identifier 226a and the encrypted credential bundle 240a that was generated by the trusted client device 202a using the device key 242a to encrypt the user's credential bundle. The unencrypted credential bundle is not stored in the vault service provider 208 nor is the device 1 key 224a that is stored only in local storage of the trusted client device 202a. The trusted client device 202a generates the encrypted credential bundle 240a by encrypting the second key 220 and the first key 222 using the device 1 key 242a and sends the encrypted credential bundle 240a to the vault service provider 208 to store in association with the user and the client device 202a in the trusted client device data storage 238a. As shown in the example illustrated in FIG. 2B, in some implementations a device 1 key ID 242a corresponding to the device 1 key 224a is also sent to the vault service provider 208 and stored in the trusted client device data storage 238a.

In some embodiments, the vault service provider 208 may also generate a session token 1 228a during enrollment of the trusted client device 202a to use in communications between the trusted client device 202a and the vault service provider 208. As shown in FIG. 2B, the session token 1 228a may be stored in the local storage of the trusted client device 202a as well.

FIG. 2B illustrates examples of data elements that may be stored on untrusted client device 202b and vault service provider 208 as a result of untrusted client device 202b being enrolled as a trusted client device. Similar to the trusted client device 202a, the untrusted client device 202b has a client application 206b operating thereon and, in the process of enrolling the untrusted client device 202b, the untrusted client device 202b obtains information for SSO and/or passwordless sign-on authentication for access to the vault service provider, as described below with reference to FIGS. 3E, 3F, 4 and 7. For example, as depicted in FIG. 2B, during the process of enrollment, the client application 206b may generate a device 2 key 224b for the client device 202b, store the device 2 key 224b in local storage on the client device 202b, send a key ID 242b corresponding to the device 2 key 224b to the vault service provider 208 for storage in association with the user and the client device 202b in untrusted client device data storage 238b, and receive a unique device 2 identifier 226b. Similar to the trusted client device 202a, the client device 202b may also include identity provider login information 230b, which may include an e-mail address and a password used by the identity provider 204 to confirm the user's identity for SSO. If the client device 202b has successfully signed-on to the vault service provider 208 via SSO, the client device 202b may also have a reauthentication token 237b stored thereon in a secure element 236b that is unlockable via biometrics. As also shown in FIG. 2B, once the client device 202b has been enrolled as a trusted client device for SSO via identity provider 204 and/or passwordless sign-on access to the vault service provider 208, the client device 202b may include security data that allows the user to access the user's vault 212 provided by the vault service provider 208, such as a device 2 identifier 226b, and a session token 228b. If the client device 202b has been enrolled as a trusted client device for SSO access to the vault service provider 208 via identity provider 204, the client device 202b may include identity provider login information 230b that may be provided to identity provider 204 to confirm the user's identity for SSO. In addition, or instead, if the client device 202b has been enrolled as a trusted client device for passwordless sign-on access to the vault service provider 208, the trusted client device 202b may include the passkey 233 stored in a secure data element 232b for use in accessing passwordless sign-on to the vault service provider 208.

It is noted that the trusted client device 202a and/or the untrusted client device 202b may be a browser executing on a computing device, in which case the client application 206a or 206b may be a browser-based client application. A browser-based client application may operate as a new client device to be enrolled when the page on which the browser-based application is operated is opened.

As noted above, the trusted client device 202a may operate as a verifying device for approving an untrusted client device (e.g. client device 202b) for use by the user for SSO and/or passwordless sign-on. The trusted client device 202a may need to be signed-on to the vault service provider 208 to operate as a verifying device as described below.

### Single Sign-On Authentication

FIGS. 3A, 3B and 3C are flow diagrams illustrating example operations of a method 300 for single sign-on to a vault provided by a vault service provider, according to an example embodiment of the present disclosure. The example illustrated in FIGS. 3A-3C utilizes an encrypted credential bundle that is stored in association with a user and a trusted client device in a vault service provider. The encrypted credential bundle has been encrypted using a device key generated on the client device. The encrypted credential bundle is decrypted on the client device using the device key. Zero knowledge is maintained because the vault service provider cannot decrypt the encrypted credential bundle. The unencrypted credential bundle is not stored in permanent storage anywhere and only decrypted on the client device upon confirmation of the identity of the user for which the client device is enrolled as a trusted client device for SSO authenticated access to the user's vault on the vault service provider.

With reference to FIG. 3A, the example method 300 is initiated when an SSO enabled account is selected in a client application operating on a user's client device, as indicated at 310. In response to the selection, the client application sends a request to a vault service provider server 308 to start a SSO process, as indicated at 312. As shown in FIG. 3A, this step may involve the vault service provider server 308 generating attributes needed to initiate the SSO flow with the identity provider. For example, as shown in FIG. 3A, the vault service provider server 308 may generate a state value and Proof Key for Code Exchange (PKCE) verifier and respond to the request with a complete HTTP redirect to the identity provider that includes a URI containing an encoded version of the PKCE verifier as a PKCE challenge and opaque state and nonce fields, which may guard the vault service provider server 308 and the identity provider from forgery and injection attacks. The URI may also contain a redirect_uri field which tells the identity provider where to submit the response after authenticating. This URI will typically point to the client application operating on the user's client device. As shown in FIG. 3A, in some implementations the response from the vault service provider server 308 may be a HTTP 302 response. In some implementations, the request sent by the client application and the response sent by the vault service provider server 308 at 312 may be as follows:

### Client Device Sends:

POST/v1/auth/sso/oidc/start

```
{
  // read sign-in domain if accountUUID not provided
  ″accountUuid″: ″eyJhbGciOiJSUzI1N″ // optional
  “userUuid”: “ASDF90238QWERTY” // optional
  ″KeyId″ : “asfjl2309sdaa14” // optional
}
```

where accountUuid is a unique identifier associated with the user's account with the vault service provider, userUuid is a unique identifier associated with the user, and KeyId is a key identifier for a device key of the client device.

### Server Response:

```
# HTTP 302 Found
https://idp.com/authorize?
  response_type=code
  &scope=openid%20email%20offline_access
  &client_id=s6BhdRkqt3
  &state=af0ifjsldkj
  &nonce=tGzv3JOkF0X
  &redirect_uri=android://vaultserviceprovider/sso/oidc
  &code_challenge=SplxlOBeZQQ
  &code_challenge_method=sha256
```

Responsive to the HTTP redirect received from the vault service provider server 308, at 314 a browser on the user's client device may redirect the user to the SSO sign-in page for the identity provider as a prompt for the user to provide their SSO sign-in credentials to sign-in to the identity provider. For example, as shown in FIG. 3A, the user may submit their SSO sign-in credentials to an identity provider server 304. If the sign-in with the identity provider server 304 is successful, the identity provider server 304 sends a response that includes an authorization code and a state value.

At 316, the client application sends a request to the vault service provider server 308 to complete the SSO process. This request includes the authorization code and state value received from the identity provider server 304. As shown in FIG. 3A, the vault service provider server 308 may use the state value to verify the identity provider server's response. If the vault service provider server 308 cannot verify the state value, then it may assume the response from the identity provider server 304 is forged. On the other hand, if the verification is successful, then the vault service provider server 308 may initiate a back-channel code exchange with the identity provider server 304 to request an ID token directly from the identity provider server 304, as indicated at 317. To do so, the vault service provider server 308 may pass the authorization code, as well as the PKCE verifier and original redirect URI to the identity provider server 304 without needing to pass through the client application or the browser on the client device. If the identity provider server 304 provides the requested ID token, the vault service provider server 308 will decode the ID token in order to verify the identity assertion. For example, in some implementations this verification may involve verifying: the signing algorithm; the issuer, subject and audience; the amount of time elapsed since the authentication timestamp; the token issue and expiration timestamps; and the nonce. In some implementations, the request sent by the client application and the response sent by the vault service provider server 308 at 316 may be as follows:

### Client Device Sends:

POST/v1/auth/sso/oidc/verify

```
{
  “device”: {
    “deviceUUID”: “abc123def456xyz”,
    “clientName”: “...”,
    “clientVersion”: “...”,
    “name”: “...”,
    “osName”: “...”,
    “osVersion”: “...”,
  }
  ″code″: ″SplxlOBeZQQYbYS6WxSbIA″,
  ″state″: ″af0ifjsldkj″
}
```

### Server Response:

### Success:

```
# HTTP 200 OK
{
  ″type″ : ″found″ or ″must_enroll_initial_device″ or
″device_not_enrolled″
  ″user″: {
    “accountUUID”: “abc123def456xyz”,
    “userUUID”: “QYbYS6WxSbIA21la”,
    ″email″: ″yyy@zzz.com″
    “sessionID”: “xyzd1hjg67ghjs”
  },
  ″auth″ : {
    ″encCredentials″: {
      ″ciphertext″: ″ckI3So7fYcqkuklX...″,
      ″encrypted_key″: ″WacCTMGNSljQtGCRQb1Zq...″,
      ″iv″: ″Box2l36K...″,
      ″protected″: ″eyJhbGciOiJS...″,
      ″tag″: ″Ty-a-M3E52ldf2...″
    },
    ″v″: 1,
    ″accountKeyFormat″: ″A2″,
    ″accountKeyUuid″: ″GWM4R8″,
    ″userAuth″: {
      ″alg″: ″PBESg-HS256″,
      ″iterations″: 10000,
      ″method″: ″SRPg-4096″,
      ″salt″: ″WSwigQtQpxqYAri592W1lg″
    }
  }
}
```

At 318, if the vault service provider server 308 is unable to verify the identity assertion, the vault service provider server 308 returns an error message (e.g., an HTTP 401 error message) to advise the user that the SSO authentication attempt failed, as indicated at 319. On the other hand, if the identity assertion provided by the identity provider server 304 is verified, the method 300 proceeds to step 320 (see FIG. 3B), in which the vault service provider server 308 returns identity attributes to the client application. The vault service provider 308 may also create and save an unverified session for the user, in which case the vault service provider 308 may also send a session identifier (sessionID) for the unverified session to the client application. The identity attributes returned by the vault service provider server 308 may include user identity information such as the email, user universal unique identifier (UUID), and account UUID. The vault service provider server 308 returns this information to the client application so that it can perform follow up actions such as if the email was recently changed or if this is the first time doing SSO and the client needs to register the account for future logins.

At 322, if the client application is unable to find a device key for the tuple (user, account, device) stored locally on the client device, the client application may generate such a device key, as indicated at 323. On the other hand, if the client application finds such a device key at 322 or generates one at 323, then at 324 the client application may send a key ID for the device key to the vault service provider server 308 to be used as a key ID for the device key of the client device. In some embodiments, the device key may be a symmetric key (e.g., a symmetric 256-bit key) that is generated using a Cryptographically Secure Pseudo-Random Number Generator (CSPRNG).

At 326, the vault service provider server 308 checks for an encrypted credential bundle associated with the user and the client device on which the client application is operating. For example, the vault service provider may check for an encrypted credential bundle for the tuple (user, device, Key ID, account). If such an encrypted credential bundle is not found, then at 328 the vault service provider server determines whether the user has at least one other client device enrolled as a trusted device that could act as a verifying device to verify the user for SSO authentication on the current client device. Depending on the result of the inquiry at 328, the method may either proceed to step 340 (see FIG. 3D) or step 360 (see FIG. 3E), as discussed in further detail below with reference to FIGS. 3D and 3E. On the other hand, if the vault service provider server 308 finds an encrypted credential bundle associated with the user and the client device at 326, then method 300 proceeds to step 330 (see FIG. 3C), in which the vault service provider server 308 returns the encrypted credential bundle to the client application. In some implementations, the request sent by the client application at 324 and the response sent by the vault service provider server 308 at 330 may be as follows:

### Device Sends:

GET/v2/auth/devicecredentials?keyID=efe15f8dadae . . .

### Server Response:

### Success:

```
# HTTP 200 OK
{
  ″encCredentials″: ″<JWE>″,
  // schema id for encrypted credentials
  “v”: 1
  ″accountKeyFormat″: ″TD″,
  ″accountKeyUuid″: ″GWM4R8″,
  ″userAuth″: {
    ″alg″: ″PBESg-HS256″,
    ″iterations″: 10000,
    ″method″: ″SRPg-4096″,
    ″salt″: ″WSwigQtQpxqYAri592W1lg″
  }
}
```

Referring again to FIG. 3C, at 332 the client application decrypts the encrypted credential bundle using its locally stored device key to obtain the first key and the second key as described earlier. In some embodiments, using the device key to decrypt the encrypted credential bundle comprises: deriving a symmetric decryption key using the device key (e.g., using the device key as IKM to a key derivation function to derive the symmetric decryption key); and decrypting the encrypted credential bundle with the symmetric decryption key to obtain the first key and the second key.

At 334, the client application uses the second key to establish an authenticated/verified session with the vault service provider server 308. In some implementations, this may involve verifying the unverified session associated with the sessionID that may have been sent to the client application with the identity attributes at step 320. For example, this may involve using the second key in a PAKE with the vault service provider server 308 to establish the authenticated session without revealing the second key to the vault service provider server. For example, the PAKE may be based on a secure remote password (SRP) protocol utilizing a verifier previously generated using the second key, wherein the verifier is stored on the vault service provider server (e.g., the verifier 244 shown in FIG. 2B that was generated using the second key 220).

In some implementations, the first key and the second key may each be derived from two secrets using a process that is referred to herein as two-secret key derivation (2SKD). For example, in some implementations the two secrets may be two randomly generated values that are generated using CSPRNGs. Utilizing 2SKD as described herein can potentially prevent data stored by the vault service provider from being usable in brute force cracking attempts against either of the two secrets individually. In 2SKD, the client application derives the first key and the second key from the two secrets.

The process for deriving each of the first key and the second key may be similar, but differ at least in that they involve different salts in the key derivation function (KDF). In particular, a user will have a salt that is used for deriving the first key and a different salt that is used for deriving the second key. In both cases, the secret inputs to the key derivation process are the two secrets. In some implementations, non-secret inputs may include the salts, algorithm information, and the user's email address.

One very specific example derivation of two keys using two secrets is described below. It should be understood that this example is in no way limiting and that other key derivation processes are contemplated within the scope of the present disclosure. In one example implementation of 2SKD, a non-secret salt is combined with the user's email address and other non-secret data using Hash-based Key Derivation Function (HKDF) to create a new 32-byte salt. In cryptography, a cryptographic salt is a non-secret value that is added to either an encryption process or hashing to ensure that the results of the encryption is unique. Salts are typically random and unique. The first secret and the 32-byte salt are passed to a slow hash function, such as PBKDF2-HMAC-SHA256, for multiple iterations, e.g., 650,000 iterations. This results in 32 bytes of data, which will be combined with the result of similar processing of the second secret. In particular, the second secret may be combined with the user's non-secret account ID and an information string (to provide domain separation) by HKDF to produce 32 bytes of data that are then Exclusive-ORed (XORed) with the 32 bytes of data that resulted from the processing of the first secret. For example, in some cases the information string that is included for the purposes of domain separation may provide some information about the particular cryptography involved in the key derivation (e.g., the information string may be the name of the derivation scheme). The resulting 32 bytes of data (derived from both the first secret and the second secret) may be used as the first key (i.e., the AUK) which is used to encrypt the user's account private key that is used to decrypt the user's vault keys that are used to encrypt the user's data. By encrypting copies of vault keys with a user's account public key, it becomes easy to securely add another user to a vault by encrypting the vault key with the recipient's account public key.

The same process, but using different salts may be used to derive the second key (i.e., the SAK) which is used to establish verified/authenticated sessions with the vault service provider. Using different salts for the derivation of the two keys ensures that the derived keys are independent of each other.

With a traditional authentication system, the client (such as a web browser) sends a user secret (typically a password) to the server. The server then processes that password to determine whether or not it is correct according to its records. If the server determines that it is correct, it will consider that user authenticated.

The simplest way to prove you know a secret is to say it, and that is what the client does in a traditional system. It simply sends the username and the password to the server.

This traditional design has a number of shortcomings. The most glaring failures of traditional authentication include:
Anyone able to eavesdrop on the conversation will learn the client's secret.
If the client is talking to the wrong server it reveals its secret to that potentially malicious server.

In a typical Internet log in session, the foregoing shortcomings are addressed by Transport Layer Security (TLS) to keep the conversation between the client and the server private as it travels over a network and to prove the identity of the server to the client. However, although embodiments of the present disclosure may utilize TLS, in at least some implementations an additional layer of cryptographic security is provided by utilizing a password authenticated key exchange (PAKE) to establish an authenticated session between a client application and a vault service provider server, as described in further detail below.

There are a number of security properties that may be desirable from an authentication system, such as:
Prove client ID—Proves to the server that the user holds the user's secret.
Prove server ID—Proves to the user that the server holds the server's secret.
Eavesdropper safe—Does not reveal any information about either secret to anyone listening in on the process.
Not replayable—Cannot be replayed by someone who has recorded the process and wishes to repeat the exchange to fake a sign-in at some later time.
No secrets received—Does not reveal any information about the user's password to the server.
Session key—Establishes a new secret that can be used as an encryption key for the session.
No cracking—Server does not acquire enough information to facilitate a password cracking attack.

One approach to covering most of the desirable security properties of authentication listed above would be to find a way for the client and the server to prove to each other that they each possess the appropriate secret without either of them revealing any secrets in the process. In some implementations of the present disclosure, this is done by using a PAKE.

Using some mathematical calculations, non-limiting examples of which are described below, the server and the client are able to send each other puzzles that can only be solved with knowledge of the appropriate secrets, but no secrets are transmitted during this exchange. Furthermore, the puzzles are created jointly and uniquely during each session so that it is a different puzzle each time. This means that an attacker who records one authentication session will not be able to play that back in an attempt to authenticate.

The “key exchange” part of “PAKE” establishes a session key: A secret encryption key that the parties can use for the life of the session to encrypt and validate their communication. This session key can then be used to add an additional layer of encryption to communication between client and server. This additional layer provides authenticated encryption for the communication between client and server that is in addition to the security provided by TLS and the fundamental end-to-end encryption of user data by the vault encryption provided by the vault service provider.

A well-designed PAKE, such as Secure Remote Password (SRP) which is described in further detail below, can potentially satisfy all of the desirable security properties listed above except for one. On its own, a PAKE may still leave something crackable on the server. In particular, in a PAKE the server typically stores a long term verifier which is mathematically related to a long term authentication secret used by the client. Although this verifier is not a password hash, it can be considered one for the sake of this immediate discussion. If the client's long term secret is derived from something guessable (such as a weak password), then the verifier stored by the server could be used to help test guesses of that user password.

Measures can be taken on the server to protect the verifiers stored on the server from being captured, and the clients can use slow hashing techniques in generating the verifier in order to make brute force cracking more difficult. However, an even greater level of security can be achieved by simply ensuring that data held by the server is not sufficient to launch a cracking attempt on a secret from which the client's long term secret for the PAKE is derived. In some implementations, this is achieved by using the two-secret key derivation (2SKD) described earlier to derive the client's longer term secret for the PAKE. An attacker who captures server data would need not only to make guesses at one of the two secrets used to derive the client's longer term secret for the PAKE but would also need to have the other of the two secrets in order to check whether a guess of the first secret is correct or not.

In this way, utilizing 2SKD to derive the first key and the second key in a user's credential bundle can satisfy the final desired security property listed above. For example, as described below, in SRP the client generates a verifier that is derived from its second key (i.e., it's session authentication key) and the verifier is sent to and stored by the vault service provider server for use in establishing authenticated sessions between the client and the server. However, if the user's second key is derived using 2SKD, then the information stored on the server that is derived from the user's second key (i.e., the verifier) cannot be used to check whether a guess at one of the two secrets used in the two-secret key derivation to generate the second key is correct or not without also having the other of the two secrets. Table 1 below summarizes which of the desirable security properties listed above can be achieved with various authentication schemes.

TABLE 1
Authentication schemes and their security properties. The
“+MFA” column lists the security properties of
using traditional authentication with multifactor authentication
(MFA). The “+2SKD” column lists the security properties
of using a PAKE with two-secret key derivation. The first
column lists the desirable security properties listed earlier.

| | Traditional | +MFA | PAKE | +2SKD |
|---|---|---|---|---|
| Prove client ID | ✓ | ✓✓ | ✓ | ✓ |
| Prove server ID | x | x | ✓ | ✓ |
| No Eavesdrop | x | x | ✓ | ✓ |
| Prevent replay | x | ? | ✓ | ✓ |
| No secrets | x | x | ✓ | ✓ |
| received | | | | |
| Session Key | x | x | ✓ | ✓ |
| No cracking | x | x | x | ✓ |

### Secure Remote Password

As noted above, in a well designed PAKE, some mathematical calculations allow the server and the client to send each other puzzles that can only be solved with knowledge of the appropriate secrets, but no secrets are transmitted during this exchange. Secure Remote Password (SRP) is an example of such a PAKE that is used in some embodiments of the present disclosure.

In such embodiments, the exchange utilizes the second key from the credential bundle on the client side and a verifier derived from the second key on the server side. For the purposes of the following explanation, the variable “x” is used to represent the second key and the variable “v” is used to represent the verifier derived from x.

### Registration

The client computes x at initial registration of an account. The standards documents describing SRP that were referenced earlier, namely RFC 5054 and RFC 2945, offer the generation of x from a password, P; salt, s; and username, I; as follows:

x←H(s∥H(I∥“:”∥P)) v←g^{x} mod N

Although it is infeasible to compute P from x or to compute x from v, it is possible to use knowledge of v (and the public parameters) to test a candidate password, P′. All an opponent needs to do is compute v′ from P′ and see if v′ equals v. If v′=v then the guessed password P′ is (almost certainly) the correct password

However, as discussed earlier, the use of 2SKD in the derivation of x can effectively mitigate against such cracking attempts, and therefore in some implementations the key derivation process utilizing 2SKD that was described earlier may be used in the derivation of the keys in a user's credential bundle (in which the second key or SAK corresponds to x for the purposes of this discussion).

During first registration, the client will compute from x a verifier, v, which will be sent to the server during initial registration.

During initial registration, the client sends v to the server, along with a non-secret salt. The client and the server also need to agree on some other non-secret parameters. The verifier is the only sensitive information ever transmitted, and it is sent only during initial registration.

### Sign-on

The client will be able to compute x from the two randomly generated secrets (e.g., two randomly generated values that are generated using Cryptographically Secure Pseudo-Random Number Generators) and salts as described earlier. It is noted that, in some implementations, the client may locally store x (i.e., the second key of the credential bundle) in a way that is encrypted with keys that depend on the first key instead of recalculating it afresh at each sign-on. The server has v. Because of the special relationship between x and v, the server and client can present each other mathematical challenges that achieve the following:
1. Proves to the server that the client has the x associated with v.
2. Proves to the client that the server has the v associated with x,
3. Lets the client and server agree on a key S (i.e., a session key) which can be used for further encrypting the session.

During that exchange, no information about the user's secrets is revealed, nor is any information about x or v or S revealed to someone listening in. Furthermore, the mathematical challenge that the client and the server present to each other is different each time, so one session cannot be replayed to authenticate a later session.

At sign-on, the client will have its derived secret x, and the server will have its verifier, v. The mathematics that allows for the client and server to mutually authenticate and to arrive at a session key without exposing either secret is an extension of Diffie-Hellman key exchange (DHE). This key exchange protocol is, in turn, based on the discrete logarithm problem (DLP) and relies on the following mathematical relationship:

$${( {b}^{n} )}^{m} = {b}^{n m} \qquad ( equation 1 )$$

Equation 1 holds true even if restricted to integers and the exponentiation is modulo some number N.

The crux of the DLP is that if N and g are picked appropriately in the following equation for the verifier, v, it is easy for a computer to calculate v when given x, but it is infeasible to compute x when given v:

$$v ← {g}^{x} mod N \qquad ( equation 2 )$$

Calculating x from v (given g and N) is computing the discrete logarithm of v. To ensure that calculating the discrete logarithm is, indeed, infeasible, N must be chosen carefully. In some implementations, the particular values of N and g may be drawn from the groups defined in Kivinen, T. and M. Kojo. More Modular Exponential (MODP) Diffie-Hellman groups for Internet Key Exchange (IKE), RFC 3526 (Proposed Standard), Internet Engineering Task Force, May 2003; URL: http://www.ietf.org/rfc/rfc3526.txt (hereinafter referred to as “RFC 3526”). Given current and anticipated computing power, it may be preferable for N to have a bit-length of at least 2048 bits.

### Diffie-Hellman Key Exchange

If two parties, whom will be referred to as Alice and Bob for the sake of this discussion, have agreed on some g and N, neither of which need to be secret, then Alice can pick a secret random number α and calculate A=g^{α}(mod N). Bob can pick his own secret, b, and calculate B=g^{b} (mod N). Alice can send A to Bob, and Bob can send B to Alice.

Assuming an appropriate N and g, Alice will not be able to determine Bob's secret exponent b, and Bob will not be able to determine Alice's secret exponent a. No one listening in—even with full knowledge of g, N, A, and B—will be able to determine a or b.

There is, however, something that both Alice and Bob can calculate that no one else can. In what follows all operations are performed modulo N.

### Alice can Compute:

$$S = {B}^{a} \qquad ( equation 3 )$$

$$= {( {g}^{b} )}^{a} because B = {g}^{b} \qquad ( equation 4 )$$

$$= {g}^{b a} because of equation 1 \qquad ( equation 5 )$$

Equation 3 is what Alice actually computes because Alice knows the secret a and has been given Bob's public exponent B. But note that the secret, S, that Alice computes is the same as the result of equation 5.

### On the Other Hand, Bob can Compute:

$$S = {A}^{b} \qquad ( equation 6 )$$

$$= {( {g}^{a} )}^{b} because A = {g}^{a} \qquad ( equation 7 )$$

$$= {g}^{ab} because of equation 1 \qquad ( equation 8 )$$

From equations 5 and 8 we see that both Alice and Bob are computing the same secret, S. They do so without revealing any secrets to each other or anyone listening in.

In DHE, N and g are already known to all parties and all exponentiation is done mod N. All of the secrets used and derived during DHE are ephemeral. They are created for the individual session alone. Alice will create a new a for each session; Bob will create a new b for each session; and the derived session key, S, will be unique to that session. One advantage of this is that a successful break of these secrets by an attacker would allow the attacker to decrypt the messages of that session only.

### Authenticated Key Exchange

DHE, as described in the previous section, allows Alice and Bob to agree on an encryption key for their communication. It does not, however, include a mechanism by which either Alice or Bob can prove to the other that they are Alice and Bob. The goal, however, is to have mutual authentication between the client and server.

In order for Alice to prove to Bob that she is the same “Alice” he has corresponded with previously, she needs to hold (or regenerate) a long term secret. At the same time we do not want to transmit any secrets during authentication.

SRP builds upon DHE, but adds two long term secrets. x is held (or regenerated) by the client and v, the verifier, is stored by the server. The verifier is created by the client from x and transmitted only during initial enrollment, and that is the only time a secret is transmitted.

As described in detail earlier, x may be derived from two secrets using 2SKD. The client computes v=g^{x} and sends v to the server during initial enrollment.

During a normal sign-in, the client may pick a secret random number α and compute A=g^{α} as described above. It then sends A to the server. In some implementations, the client may send A to the server along with the user's email address (if the key derivation function used to generate x was done using the user's email address to bind the user's email address to the derived keys as described earlier).

The server picks a random number, b, but unlike unauthenticated DHE, it computes B as B=kv+g^{b} and sends that to the client.

Everyone (including a possible attacker) can now compute a non-secret u from A and B by using a hash. For example, in one non-limiting example, u may be computed as SHA256 hash of A|B. The server may calculate a raw S as

$$S = {( A {v}^{u} )}^{b} \qquad ( Equation 9 )$$

### The Client May Calculate the Same Raw S as

$$s = {( B - k {g}^{x} )}^{a + u x} \qquad ( Equation 10 )$$

The client and server will calculate the same raw S if v is constructed from x as in equation 2 and A and B are constructed as described above. In particular:

$$S = {( A {v}^{u} )}^{b}$$

$$= {( ( {g}^{a} ) {( {g}^{x} )}^{u} )}^{b} because A = {g}^{a} and v = {g}^{x} \qquad ( Equation 11 )$$

$$= {( {g}^{a + u x} )}^{b} \qquad ( Equation 12 )$$

$$= {( {g}^{b} )}^{a + u x} because of equation 1 \qquad ( Equation 13 )$$

$$= {( B - k v )}^{a + u x} because B = k v + {g}^{b} \qquad ( Equation 14 )$$

$$= {( B - k {g}^{x} )}^{a + u x} because v = {g}^{x}$$

Referring again to FIG. 3C, if Alice and Bob in the above discussion are the client and the vault service provider server, the secret S can be used as a session key to provide an additional encryption and authentication layer on the client/server communication for the authenticated session established between the client and the vault service provider server 308 at step 334. As discussed earlier, in such implementations this additional encryption and authentication layer may be in addition to the encryption and authentication provided by TLS and the authenticated encryption of the user data.

At 336, the client application uses the first key of the credential bundle to decrypt an encrypted chain of keys to unlock a corresponding vault provided by the vault service provider, which completes the user's successful sign-in, as indicated at 338. In some implementations, this may involve using the first key, or another key derived therefrom, to decrypt an encrypted personal keyset corresponding to the user's account, wherein the personal keyset is used to encrypt and decrypt a vault key used to encrypt and decrypt data in the vault. In such implementations, the client application may retrieve the personal keyset from the vault service provider server 304 after successfully authenticating with the vault service provider at step 334.

As described earlier, in some implementations the user's personal keyset may include an account key pair that includes an account private key and an account public key. In such implementations, a vault key that is used to encrypt and decrypt data in the vault may be encrypted with the account public key, and, therefore, decrypting the user's personal keyset allows the encrypted vault key to be decrypted using the account private key. In some implementations, a personal keyset may have an overall structure as follows:

| | |
|---|---|
| { | ″encPriKey″: { “. . .” }, |
| | ″encSymKey″: { ″. . .″ }, |
| | ″encryptedBy″: ″mp″, |
| | ″pubKey″: { ″. . .″ }, |
| | ″uuid″ : ″c4pxet7a. . .″ } |

In this example, it is assumed that the first key in the user's credential bundle has been assigned the key ID (kid) “mp”, and therefore the value of “mp” in the encryptedBy field indicates that the encrypted symmetric key is encrypted with the first key in the user's credential bundle, i.e., the Account Unlock Key (AUK).

The personal keyset structure in the above example contains an encrypted private key, the associated public key, and an encrypted symmetric key that is used to encrypt the private key. The encrypted symmetric key is encrypted with the first key in the user's credential bundle (i.e., the Account Unlock Key (AUK)), which in this example is identified by the key ID “mp”, using the parameters and the salt that are included with the encrypted symmetric key as shown below:

| | |
|---|---|
| { | ″encPriKey″ : { ″. . .″ }, |
| | ″encSymKey″: { |
| | ″kid″: ″mp″, |
| | ″enc″: ″A256GCM″, ″cty″: ″b5+jwk+json″ |
| | ″iv″: ″X3uQ83t1rdNIT_MG″, |
| | ″data″: ″gd9fzh81qq5BYdGZpypXvMzIfkS . . .”, |
| | ″alg″: ″PBES2g-HS256″, ″p2c″: 650000, |
| | ″p2s″: ″5UMfnZ23QaNVpyeKEusdwg″ }, |
| | ″encryptedBy″ : ″mp″, |
| | ″pubKey″: { ″. . .″ }, |
| | ″uuid″ : ″c4pxet7a. . .″ } |

In particular, in the above example, the encrypted symmetric key is encrypted with the AUK, which in turn is derived using the salt in the “p2s” field, and using the methods indicated in the “alg” and “p2c” fields. In this example, the encrypted symmetric key itself is encrypted using a 256-bit Advanced Encryption Standard with Galois Counter Mode (AES-GCM) cipher, as indicated by the “enc” field value “A256GCM”. However, it should be understood that this is merely one non-limiting example of a symmetric cipher that may be used in some embodiments of the present disclosure and the use of other symmetric ciphers is contemplated within the scope of the present disclosure.

Example details of the public and private key portions of the user's personal keyset are shown below:

| | |
|---|---|
| { | ″encPriKey″ : { |
| | “kid”: “c4pxet7agzqqhqg9yvxc2hkg8g”, |
| | “enc”: “A256GCM”, “cty”: “b5+jwk+json”, |
| | “iv”: “dBGJAy3uD4hJkfOK”, |
| | “data”: “YNz19jMUffFP_glxM5Z . . .” }, |
| | ″encSymKey″: { “. . .” }, |
| | ″encryptedBy″ : ″mp″, |
| | “pubKey”: { |
| | “alg”: “RSA-OAEP-256”, “e”: “AQAB”, |
| | “key_ops”: [“encrypt”], “kty”: “RSA”, |
| | “n”: “nXk65CscbXVuSq8143RmGWr9eI391z . . .”, |
| | “kid”: “c4pxet7adzqqvqg9ybxc2hkg8g” }, |
| | “uuid” : “c4pxet7agzqqhqg9yvxc2hkg8g” } |

In the above example, the public/private parts of the keyset are specified using JSON Web Key, which is a format for describing and storing cryptographic keys defined in Jones, M., JSON Web Key (JWK), RFC 7517 (Proposed Standard), Internet Engineering Task Force, May 2015, URL: http://www.ietf.org/rfc/rfc7517.txt (hereinafter referred to as “RFC 7517”). It is noted that the foregoing example keyset structure and contents is merely one non-limiting example that is provided for illustrative purposes only. Other keyset structures and contents are contemplated and may be used in other embodiments without departing from the scope of the present disclosure.

Referring again to FIG. 3B, as noted earlier, the vault service provider server 308 checks at 326 for an encrypted credential bundle associated with the user and the client device on which the client application is operating. For example, the vault service provider 308 may check whether it has an encrypted credential bundle stored for the tuple (email, deviceUUID, KeyID, accountUUID), where “email” is a unique email address associated with the user, “deviceUUID” is a universal unique identifier associated with the new client device, “KeyID” is a unique key ID associated with the user's device key on the new client device, and “accountUUID” is a universal unique identifier associated with a particular account of the user's. If an encrypted credential bundle is not found, then at 328 the vault service provider server determines whether the user has at least one other client device enrolled as a trusted device that could act as a verifying device to verify the user for SSO authentication on the current client device. If the vault service provider server 308 does not find at least one previously enrolled trusted device associated with the user's account, then method 300 proceeds to step 340 (see FIG. 3D), in which the vault service provider server 308 sends a message to the client application to prompt the user to enroll the client device on which the client application is operating as the initial trusted device associated with the user's account. For example, in some implementations the message sent from the vault service provider server 308 to the client application at 340 may be a hypertext transfer protocol (HTTP) 404 message.

At 342, the client application operating on the new client device provides a prompt to the user to confirm whether the user wishes to enroll the current client device as a trusted device for SSO. For example, the prompt may be provided in the form of a user interface displayed on the client device that provides a user-selectable input that allows the user to accept or decline the prompt. In some implementations, the prompt may have an associated time limit within which the user is provided with the opportunity to respond to the prompt, otherwise the enrollment process expires. At 344, if the user has accepted the prompt to enroll the new client device as a trusted device, then the method proceeds to step 348. Otherwise, if the user has not accepted the prompt at 344, then at 346 the client application operating on the new client device checks whether the user has declined the prompt or the time limit provided for responding to the prompt has expired. If so, then the enrollment expires as indicated at 378. Otherwise, if the method returns from step 346 to step 344.

If the user has accepted the prompt to enroll the new client device as a trusted device at 344, then at 348 the new client device randomly generates the first key and the second key for the user's credential bundle. For example, the new client device may generate the first key and the second key in accordance with the key derivation techniques described earlier.

At 350, the new client device encrypts the first key and the second key using the device key from the user's device key stored on the new client device (i.e., the device key described earlier with reference to steps 322 and 323 of FIG. 3B). In some embodiments, using the device key to encrypt the first key and the second key (i.e., the user's credential bundle) comprises deriving a symmetric encryption key using the device key (e.g., using the device key as IKM to a key derivation function to derive the symmetric encryption key); and encrypting the first key and the second key with the symmetric encryption key.

At 352, the new client device submits the encrypted credential bundle to the vault service provider server 308 for storage in association with: the user; the user's account with the vault service provider; the user's device key on the new client device; and the new client device.

At 354, the vault service provider server 308 stores the encrypted credential bundle for the tuple (user, device, KeyID, account), such that the encrypted credential bundle is uniquely associated with: the particular user (e.g., based on a unique user ID associated with the particular user), the particular client device (e.g., based on a universal unique ID associated with the particular client device), the particular device key used to encrypt the encrypted credential bundle (e.g., based on a key ID associated with the device key used to encrypt the encrypted credential bundle), and a particular account associated with the user (e.g., based on a universal unique identifier associated with the particular account associated with the particular user).

Once the encrypted credential bundle has been stored at the vault service provider server 308, the enrollment of the new client device as a trusted client device is complete and the client application operating on the client device can now proceed with SSO authentication as described above with reference to FIGS. 3A-3C. In addition, the now trusted client device can be used as a verifying device to verify additional client devices as trusted devices during future enrollment flows, as described below with reference to FIGS. 3E-3F.

Referring again to FIG. 3B, if the vault service provider server 308 does not find an encrypted credential bundle associated with the user and the client device at 326, but determines at 328 that the user already has at least one other client device enrolled as a trusted device that could act as a verifying device for the new client device on which the client application is operating, then the method 300 proceeds to step 360 (see FIG. 3E), in which the vault service provider server 308 sends a message to the client application to prompt the user to enroll the client device on which the client application is operating as a trusted device associated with the user's account. For example, in some implementations the message sent from the vault service provider server 308 to the client application at 360 may be a HTTP 404 message.

At 362, the client application operating on the new client device provides a prompt to the user to confirm whether the user wishes to enroll the current client device as a trusted device for SSO. For example, the prompt may be provided in the form of a user interface displayed on the client device that provides a user-selectable input that allows the user to accept or decline the prompt. In some implementations, the prompt may have an associated time limit within which the user is provided with the opportunity to respond to the prompt, otherwise the enrollment process expires. At 364, if the user has accepted the prompt to enroll the new client device as a trusted device, then the method proceeds to step 368. Otherwise, if the user has not accepted the prompt at 364, then at 366 the client application operating on the new client device checks whether the user has declined the prompt or the time limit provided for responding to the prompt has expired. If so, then the enrollment expires as indicated at 378. Otherwise, if the method returns from step 366 to step 364.

If the user has accepted the prompt to enroll the new client device as a trusted device at 364, then at 368 the client application operating on the new client device causes the new client device to render a one time code input interface configured to allow the user to input a one time code (e.g., a six-character alphanumeric code) for authentication, as described below. In addition, the client application operating on the new client device may send a “Begin Enrollment” request to the vault service provider server 308 to confirm that the user wishes to proceed with enrollment of the new client device as a trusted device.

At 370, the vault service provider server 308 creates an enrollment record associated with an enrollment UUID, associates the new client device's UUID with the enrollment UUID, and broadcasts the enrollment UUID in push notifications to the one or more trusted devices associated with the user to notify the user's trusted device(s) that a request to enroll a new client device has been received. Such messages may contain only public information such as the location of the new client device and the enrollment UUID.

At 372, each trusted device that acknowledges the new enrollment push notification renders a prompt for the user to begin enrollment of the new client device. The vault service provider server 308 waits to receive an acknowledgement from one of the user's trusted device(s) confirming that it will act as a verifying device for enrollment of the new client device. In some implementations, the user will need to unlock the client application on the trusted device after interacting with the notification. Interactions between the trusted device acting as the verifying device and the vault service provider server may utilize an SRP authenticated session to provide an additional layer of encryption and authentication protection. In some implementations, the trusted device on which the user acknowledges the enrollment notification may send an authenticated PATCH request to the vault service provider server 308 to associate the trusted device's UUID with the enrollment record for the new client device. To prevent race conditions, the vault service provider server 308 may respond with a confirmation of whether it was the first trusted device to send an authenticated PATCH request. Typically, the first trusted device to perform the request will continue with the enrollment flow. In some implementations, the vault service provider server 308 may send a message (e.g., an HTTP 409 Conflict message) to any other trusted device from which it received an authenticated PATCH request to advise that it was not the first to claim the enrollment.

In some implementations, if the vault service provider server 308 determines at 374 that an acknowledgement to the enrollment notification has not been received within a time limit, then the enrollment expires, as indicated at 378. On the other hand, if the vault service provider server 308 receives an acknowledgement from at least one of the user's trusted devices within the time limit, then the method 300 proceeds to step 380 (see FIG. 3F), in which the vault service provider server 308 sends a message to the first trusted device that responded to the enrollment notification to acknowledge it as the verifying device and sends messages to the user's other trusted device(s) to dismiss the enrollment notification.

At 382, the trusted device acting as the verifying device generates and renders a one-time, alphanumeric code (referred to herein as the “device code”) and instructs the user to enter it into the prompt on the enrollment interface on the new client device. For example, rendering the device code on the verifying device may involve rendering the device code on a display of the verifying device.

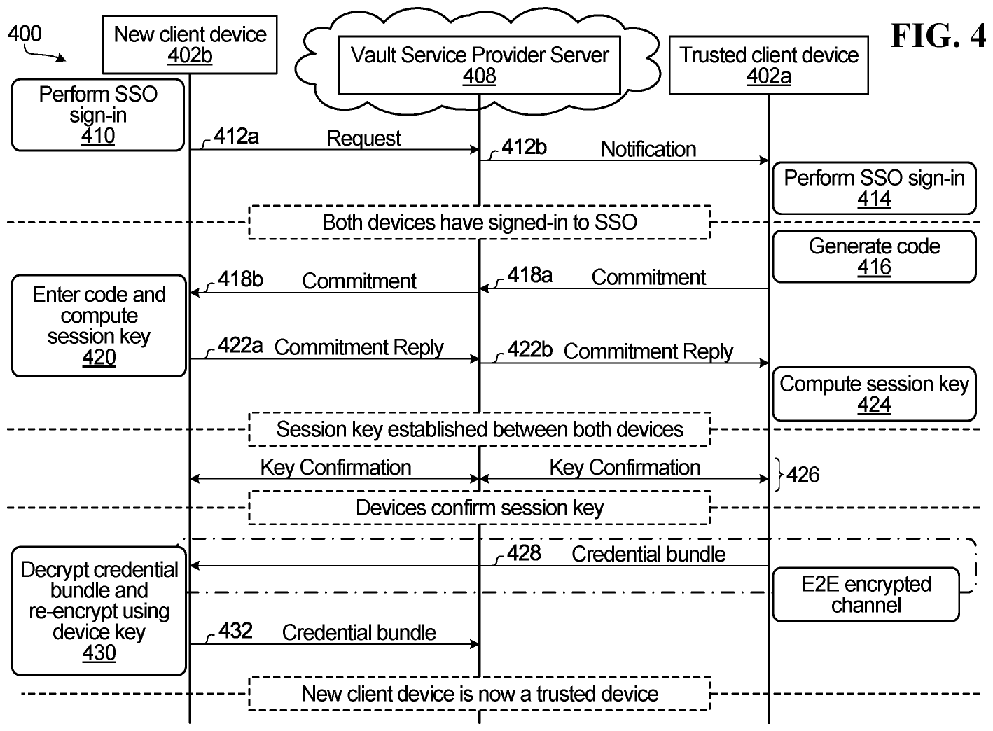

At 384, the new client device and the verifying device complete a password authenticated key exchange (PAKE) using the device code as a shared secret to establish a session key for cryptographically secured end-to-end encrypted communication between the verifying device and the new client device via the vault service provider server 308, as discussed in further detail below with reference to FIG. 4.

At 386, the verifying device encrypts the user's credential bundle using the session key established in step 384 and sends the encrypted credential bundle to the vault service provider server 308 for retrieval by the new client device. In some embodiments, using the session key to encrypt the user's credential bundle comprises: deriving a symmetric encryption key using the session key (e.g., using the session key as IKM to a key derivation function to derive the symmetric encryption key); and encrypting the credential bundle with the symmetric encryption key.

At 388, the new client device retrieves the encrypted credential bundle from the vault service provider server 308 and decrypts it using the session key to obtain the user's credential bundle, including the first key and the second key described earlier. Similar to the symmetric encryption of the user's credential bundle using the session key at 386, in some embodiments using the session key to decrypt the encrypted credential bundle at 388 comprises: deriving a symmetric decryption key using the session key (e.g., using the session key as IKM to a key derivation function to derive the symmetric decryption key); and decrypting the encrypted credential bundle with the symmetric decryption key to obtain the first key and the second key.

At 390, the new client device encrypts the user's credential bundle, including the first key and the second key, using its device key.

At 392, the new client device submits the encrypted credential bundle encrypted using the new client device's device key to the vault service provider server 308 for storage in association with: the user; the new client device; the Key ID associated with the new client device's device key; and the account of the user.

At 394, the vault service provider server 308 stores the encrypted credential bundle for the tuple (user, device, KeyID, account), such that the encrypted credential bundle is uniquely associated with: the particular user (e.g., based on a unique user ID associated with the particular user), the particular client device (e.g., based on a universal unique ID associated with the particular client device), the particular device key used to encrypt the encrypted credential bundle (e.g., based on a key ID associated with the device key used to encrypt the encrypted credential bundle), and a particular account associated with the user (e.g., based on a universal unique identifier associated with the particular account associated with the particular user).

Once the encrypted credential bundle has been stored at the vault service provider server 308 at 394, the enrollment of the new client device as a trusted client device is complete and the client application operating on the client device can now proceed with SSO authentication as described above with reference to FIGS. 3A-3C. In addition, the now trusted client device can be used as a verifying device to verify additional client devices as trusted devices during future enrollment flows.

FIG. 4 is a message flow diagram illustrating example operations of a method 400 for enrolling a new client device 402b as a trusted client device for single sign-on using an existing trusted client device 402a as a verifying device according to an embodiment of the present disclosure. The identity provider that provides SSO authentication for the client devices 402a and 402b is not shown in FIG. 4 for the sake of simplifying the drawing.

At 410, new client device 402b performs a SSO sign-in with an identity provider (not shown) and then sends a request to the vault service provider server 408, as indicated at 412a, to request that the new client device 402b be enrolled as a trusted client device for SSO authentication of the user to access a vault provided by the vault service provider. As indicated at 412b, the vault service provider server 408 in turn sends a notification to trusted client device(s) associated with the user, which in this example includes at least client device 402a, to notify the existing trusted device(s) that a new client device has requested enrollment as a trusted client device for SSO authentication.

In the example depicted in FIG. 4, it is assumed that the trusted client device 402a is the first trusted client device to acknowledge the enrollment notification indicated at 412b and the vault service provider server 408 has in turn acknowledged that the trusted client device 402a will act as the verifying device for enrollment of the new client device 402b. If the user elects to continue the process they will be required to sign in to SSO on the trusted client device 402a unless they already have an active session from recent use. In the example depicted in FIG. 4 it is assumed that the trusted client device 402a does not have an active SSO authenticated session. As such, at 414, the trusted client device 402a performs a SSO sign-in with an identity provider (not shown), which may or may not be the same identity provider with which the new client device 402b performed its own SSO sign-in at 410.

At 416, the trusted client device 416 generates and renders a device code kₑ and instructs the user to enter the device code into a prompt on an enrollment interface on the new client device 402b. For example, in some implementations the device code kₑ may be a 6-character alphanumeric code generated according to:

$${k}_{e} ← \$ KGe n ( 6 ) \qquad ( Equation 15 )$$

where KGen(6) is a key generation function configured to generate a 6-character alphanumeric key.

The device code kₑ generated and rendered by the trusted client device 402a is then used as a shared secret to complete a password authenticated key exchange (PAKE) to establish a session key for cryptographically secured end-to-end (E2E) encrypted communication between the trusted client device 402a and the new client device 402b via the vault service provider server 408. In particular, as described in further detail below, the particular PAKE used to establish a session key for E2E encrypted communication between the client devices 402a and 402b in the example depicted in FIG. 4 is based on a balanced composable PAKE cryptographic protocol, such as the CPace protocol described in Abdalla, M., B. Haase, and J. Hesse, CPace, a balanced PAKE, composable January 2023. URL: https://datatracker.ietf.org/doc/draft-irtf-cfrq-cpace/, hereinafter referred to as “CPace”, which allows two parties that share a low-entropy secret (password) to derive a strong shared key without disclosing the secret to offline dictionary attacks.

The trusted client device 402a initiates setting up a trusted channel with the new client device 402b using CPace by using the device code kₑ to create a CPace handshake hs. For example, in some implementations the Cpace handshake hs is generated according to:

$$h s = C P a c {e}_{h s} ( {k}_{e} ) \qquad ( Equation 16 )$$

where CPaceₕₛ( ) is a cipher function that both client devices 402a and 402b know.

The CPace handshake hs is sent to the vault service provider 408 as part of a CPace commitment, as indicated at 418a.

The new client device 402b fetches the CPace commitment that includes the CPace handshake hs, as indicated at 418b, and requests the user to enter the device code kₑ rendered on the trusted client device 402a. After the user enters the device code kₑ, the new client device 402b computes a CPace reply r from information in both the CPace handshake hs and the device code kₑ, as indicated at 420. For example, in some implementations the Cpace reply r is generated according to:

$$r ← C P a c {e}_{r} ( {k}_{e} , hs ) \qquad ( Equation 17 )$$

The reply r is sent to the vault service provider server 408 as part of a CPace commitment reply, as indicated at 422a. The trusted client device 402a fetches the CPace commitment reply that includes the CPace reply r as indicated at 422b, and both devices use the shared values for the device code kₑ, the CPace handshake hs and the CPace reply r to compute a shared session key kₛ, as indicated at 420 and 424. For example, in some implementations the shared session key kₛ is computed according to:

$${k}_{s} ← C P a c {e}_{k} ( {k}_{e} , hs , r ) \qquad ( Equation 18 )$$

Before the keys are used it is important to verify the keys have been exchanged correctly. After all, the new device may have accidentally entered the wrong setup code or there may have been something nefarious that has tried to influence the messages sent between the trusted client device 402a and the new client device 402b.

To verify the session keys derived by the two client devices 402a and 402b, both client devices compute verification values using a Hash-based Message Authentication Code (HMAC) digest of the messages each client device received from the other using the key they both derived. For example, in some implementations, each of the client devices 402a and 402b may begin the verification process by computing a verification key kᵥ according to:

$${k}_{v} ← subkey ( {k}_{s} ) \qquad ( Equation 19 )$$

where subkey( ) is a subkey generation function and kₛ is the value of the session key derived by the respective client device.

The trusted client device 402a may then calculate a verification value vₐ as a HMAC digest of the verification key kᵥ and the CPace handshake hs according to:

$${v}_{a} ← H M A C ( {k}_{v} , hs ) \qquad ( Equation 20 )$$

For its part, the new client device 402b calculates a verification value vₐ as a HMAC digest of the verification key kᵥ and the CPace reply r according to:

$${v}_{b} ← H M A C ( {k}_{v} , r ) \qquad ( Equation 21 )$$

The client devices 402a and 402b If the values don't match on either client device the setup process may be broken off and started over again.

The two client devices 402a and 402b send the verification values vₐ and v_{b} to one another via the vault service provider server 408 and verify whether the value computed by the other matches their own, as indicated at 426. If the values don't match on either client device the setup process may be broken off and started over again.

If the verification values vₐ and v_{b} match, the trusted client device 402a uses the session key kₛ to encrypt the credential bundle cb to generate an encrypted credential bundle E_{scb} and sends the encrypted credential bundle E_{scb} to the new client device 402b via the vault service provider server 408, as indicated at 428. For example, in some implementations, using the session key kₛ to encrypt the credential bundle cb to generate the encrypted credential bundle E_{scb} involves deriving a session subkey kₛ from the session key kₛ, encrypting the credential bundle cb with the session subkey kₛ to generate the encrypted credential bundle E_{scb} according to:

$${k}_{s} ← subkey ( {k}_{s} ) \qquad ( Equation 22 )$$

$${E}_{s c b} ← E n c ( {k}_{S} , cb ) \qquad ( Equation 23 )$$

For its part, the new client device 402b similarly uses the session key kₛ to decrypt the encrypted credential bundle E_{scb} to obtain the credential bundle cb, as indicated at 430. For example, in implementations in which the encrypted credential bundle E_{scb} is generated in accordance with Equations 22 and 23 above, the new client device 402b may similarly derive the session subkey kₛ in accordance with Equation 22 and then decrypt the encrypted credential bundle E_{scb} to obtain the credential bundle cb according to:

$$c b ← D e c ( {k}_{S} , {E}_{s c b} ) \qquad ( Equation 24 )$$

The new client device 402b is now ready to authenticate to the vault service provider server 408 with the credentials in the credential bundle cb. For example, at this stage the new client device 402b may generate a random device key k_{d}, store it locally, and then encrypt the credential bundle cb using the device key to generate a new encrypted credential bundle E_{dcb} according to:

$${k}_{d} ← \$ KGen ( ) \qquad ( Equation 25 )$$

$${E}_{d c b} ← E n c ( {k}_{d} , cb ) \qquad ( Equation 26 )$$

The new client device 402b stores the newly encrypted credential bundle E_{dcb} on the vault service provider server 408 and completes the trusted device setup process, as indicated at 432. At this stage, the new client device 402b is now a trusted client device itself and can be used for SSO sign-in and can be used as a verifying device to enroll other new client devices.

### Biometric Unlock

The SSO sign-in process described above with reference to FIGS. 1-3 assumes the client device is online and able to communicate with the identity provider and the vault service provider server in order to complete the SSO sign-in with the identity provider and obtain the credential bundle from the vault service provider. In some implementations, offline access to vault contents is provided when a user successfully performs a biometric authentication. For example, such functionality may leverage the biometric authentication mechanisms provided by platforms such as Windows, Linux, macOS, iOS and Android, as described in further detail below. In particular, in such implementations, biometrics are used to securely store a user's credential bundle and a reauthentication token locally on-device.

When unlocking with biometrics, the user's device-stored credential bundle is used to decrypt vault contents locally on the client device so vault contents can be accessed offline. Additionally, the client application operating on the client device keeps track of a reauthentication token that is used to perform quick reauthentication with the vault service provider server within a limited timeframe so it can synchronize vault data when the client device is online again without requiring the client application to reach out to the identity provider server to reauthenticate. In such implementations, the vault service provider temporarily delegates responsibility of authenticating a user to the user's client device instead of the identity provider.

In such implementations, a reauthentication token may be requested every time a user uses biometrics to unlock their SSO enabled account with the vault service provider. In such implementations, the reauthentication token is cryptographically protected at least by Transport Layer Security (TLS) when transferred from the vault service provider server to the client device.

On macOS, iOS and Android devices, the quick biometric unlock functionality described above may be protected by the respective platform's built-in secure elements. On devices with operating systems that do not have built-in secure elements available for such uses, such as Windows and Linux devices, the reauthentication token may instead be stored in protected operating system memory while the vault service provider client application is running either when locked or unlocked. On platforms that store the reauthentication token in memory, the reauthentication token is lost when the client application closes or restarts, so the user will need to sign into the vault service provider again, e.g. via SSO by reauthenticating with the identity provider.

FIG. 5 is a message flow diagram illustrating example operations of a method 500 for unlocking a vault on a trusted client device 502 using biometrics according to an embodiment of the present disclosure. In this example, the trusted client device 502 has a client application 506 operating thereon and it is assumed the trusted client device 502 has been enrolled as a trusted client device for SSO authenticated access to a vault service provider server 508. In particular, as shown in FIG. 5, the trusted client device 502 includes security data for accessing the vault service provider server 508, including a device key 524 and a device identifier 526. Moreover, in this specific example, it is assumed that the trusted client device 502 has previously signed in with the vault service provider server 508 and received a reauthentication token 538 that it has locally stored on-device in a secure element 536 that is unlockable via biometric sensor(s) 550.

At 560, the user unlocks the device secure element 536 using biometrics on the client device, e.g., via biometric sensor(s) 550 (e.g., a fingerprint scanner or camera(s) for facial recognition), to retrieve the reauthentication token 538, which is then sent to the vault service provider server 508 at 562.

At 564, the vault service provider server 508 verifies the reauthentication token and, if the verification is successful, returns the encrypted credential bundle corresponding to the user's account on the trusted client device 502, as indicated at 566.

At 568, the encrypted credential bundle is decrypted using the device key 524 stored on the trusted client device 502 to obtain the unencrypted credential bundle, including the first key and the second key, as described earlier.

At 570, the second key is used to establish an authenticated session between the trusted client device 502 and the vault service provider server 508, and the first key is used to unlock the user's vault by decrypting the chain of keys required to encrypt and decrypt data elements in the vault, as indicated at 572. At this stage, vault data may be re-synchronized between the trusted client device 502 and the vault service provider server 508, as indicated at 574.

### Passwordless Authentication

As mentioned earlier, in addition to providing techniques to facilitate SSO authentication, aspects of the present disclosure also provide techniques to facilitate passwordless authentication for access to a vault provided by a vault service provider. Passwordless authentication offers many potential advantages over SSO from the perspective of the vault service provider. Firstly, passwordless authentication offers a potentially unified view of user identity. Instead of the vault service provider and a separate service maintaining a record of a user (as in SSO), providing passwordless authentication makes the vault service provider the sole owner of user identity records. This has the possible benefit of potentially enabling the vault service provider's auditing tools to provide a complete view of what a user has been up to, such as an activity log and events streaming. A second potential benefit to passwordless authentication from the perspective of a vault service provider relates to the utilization of direct authentication rather than relying upon token passing. In particular, rather than relying upon the passing of authorization information in the form of tokens, users would authenticate to the vault service provider directly from their devices. For example, passwordless authentication using passkeys, as described in further detail below, would avoid requiring the user to indirectly authorize with a token obtained from a separate service (i.e., an identity provider service in SSO). Client-managed indirect authorization tokens are potentially a weak point because passing a token between multiple systems/services gives it a larger exposure window. In contrast, direct passkey authentication avoids token passing. In addition, avoiding passing around indirect authorization information potentially speeds up the passwordless unlock process by having fewer requests a client needs to make to complete unlock.

FIG. 6 is a message flow diagram illustrating example operations of a method 600 for passwordless sign-on to a vault provided by a vault service provider according to an embodiment of the present disclosure. In this example, a trusted client device 602 has a client application 606 operating thereon and it is assumed the trusted client device 602 has been enrolled as a trusted client device for SSO authenticated access to a vault service provider server 608. In particular, as shown in FIG. 6, the trusted client device 602 includes security data for accessing the vault service provider server 608, including a device key 624 and a device identifier 626. Moreover, in this specific example, it is assumed that the trusted client device 602 has previously generated a passkey associated with the user's account with the vault service provider. As shown in FIG. 6, the passkey private key 634 is locally stored on the trusted client device 602 by a passkey manager 632 that is unlockable via biometric sensor(s) 650 and a corresponding passkey public key 646 is stored on the vault service provider server 608.

At 660, to initiate a sign-on process for a particular account of a user, the client application 606 sends a request to the vault service provider server 608 to inquire what authentication methods are available for the given account. For example, the vault service provider server 608 may map the request context to existing sign-on settings for the given account to determine whether to allow regular authentication via an account password, via SSO authentication and/or via passwordless authentication. For the purposes of this example, it is assumed that the account selected by the user is authorized for at least passwordless authentication, and therefore the response from the vault service provider server 608 to the inquiry includes a passkey challenge, as indicated at 662.

At 664, after receiving the passkey challenge, the client application 606 causes a passkey prompt to be displayed to the user on the trusted client device 602. If the user provides the requested biometrics/device credential(s), e.g., via biometric sensor(s) 650, the passkey manager (e.g., the operating system of the trusted client device 602) completes the passkey challenge using the passkey private key 634 to sign the passkey challenge to generate a passkey assertion. The passkey assertion and the device ID 626 are then sent to the vault service provider server 608, as indicated at 666.

At 667, the vault service provider server 608 verifies the passkey assertion using the passkey public key 646 to verify that the passkey challenge was signed with the corresponding passkey private key 634. If the verification is successful, the vault service provider server 608 returns user information, the encrypted credential bundle corresponding to the user's account on the trusted client device 602 (i.e., the encrypted credential bundle associated with the user's account corresponding to the passkey private/public keys 634/646 and the device ID 626) and a sign-in token to the trusted client device 602, as indicated at 668. The user info returned at 668 may be used to display information about the user that is signed in via the passkey challenge and the sign-in token may be used to securely authenticate future communications from the client to the server.

At 670, the encrypted credential bundle is decrypted using the device key 624 stored on the trusted client device 602 to obtain the unencrypted credential bundle, including the first key and the second key, as described earlier.

At 672, the second key is used to establish an authenticated session between the trusted client device 602 and the vault service provider server 608, and the first key is used to unlock the user's vault by decrypting the chain of keys required to encrypt and decrypt data elements in the vault, as indicated at 674. At this stage, the user has a valid session and the keys necessary to encrypt and decrypt data elements in the vault, and can use the vault service provider in the same manner that it otherwise could following a traditional unlock or SSO unlock.

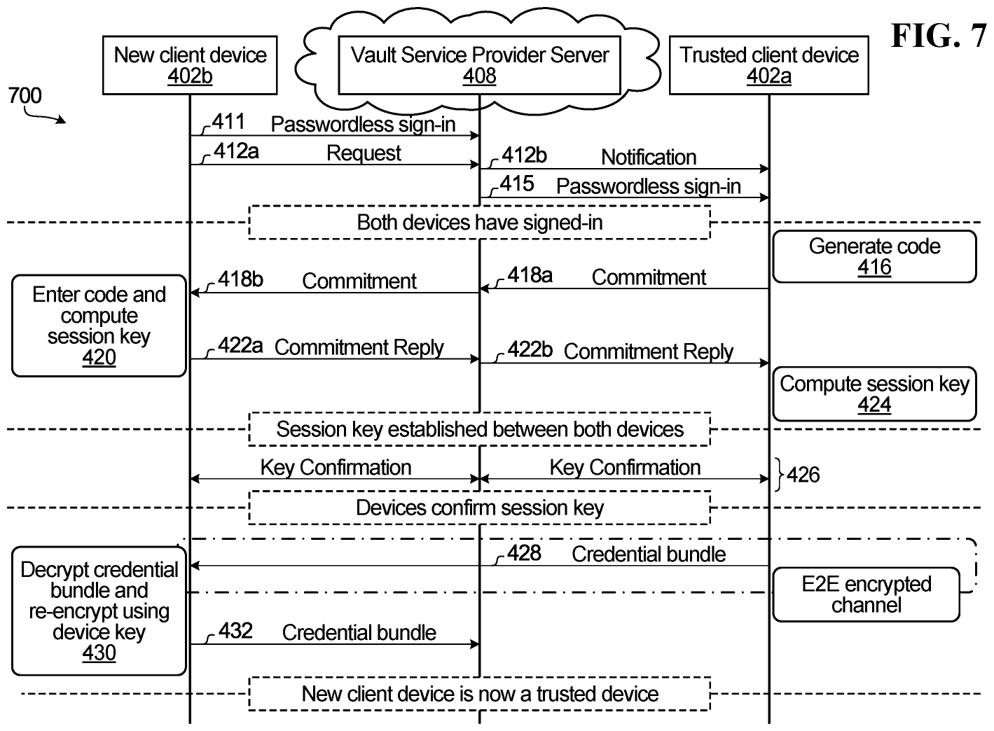

FIG. 7 is a message flow diagram illustrating operations of a method 700 for enrolling a new client device 402b as a trusted client device for passwordless sign-on using an existing trusted client device 402a as a verifying client device according to an embodiment of the present disclosure. The method 700 shown in FIG. 7 is substantially similar to the method 400 shown in FIG. 4 and only differs therefrom in that, rather than performing SSO sign-in with an identity provider at 410 and 414, in the method 700 the user performs a passwordless sign-in on each of the client devices 402b and 402a at 411 and 415, respectively. Otherwise, the subsequent steps indicated at 416-432 in the methods 400 and 700 are substantially the same.

### Symmetric Key Cryptography

The embodiments described above with reference to FIGS. 1B-7 utilize symmetric device keys for the symmetric encryption and decryption of the user's credential bundle. The use of symmetric key cryptography in this context serves to mitigate against potential Man in The Middle (MiTM) attacks that could potentially be exploited if public key cryptography were used for the encryption/decryption of the user's credential bundle.

At present, there is no robust method for a user to verify that the public key they are encrypting data to belongs to the intended recipient. As a consequence, in the context of the embodiments described herein, if public key cryptography were used for encryption/decryption of a user's credential bundle, it would be theoretically possible for a malicious or compromised vault service provider server to provide dishonest public keys to the user and run a successful MiTM attack. Under such an attack, it would be possible for the server to acquire vault encryption keys with little ability for users to detect or prevent this. In this context, there are two MiTM issues/vulnerabilities with public-key cryptography that the use of symmetric key cryptography mitigate against. The two issues are briefly outlined below.

### Issue #1: Attacker Chosen Credentials

If public key cryptography were used for encryption/decryption of a user's credential bundle (i.e., the user's first key and second key as described earlier), a malicious vault service provider server or MiTM attacker could potentially choose second key (e.g., Session Authentication Key (SAK)) and first key (e.g., Account Unlock Key (AUK)) values for a user who is logging into SSO. The ultimate impact of this issue would be that an attacker could choose which keys a client will use to encrypt new data it uploads after this authentication, which would allow an attacker to access item/vault data. Although, this would not give an attacker access to existing item/vault data.

This attack is accomplished by the attacker making use of the knowledge of a device's public key to choose these credentials, and then relaying the encrypted chosen credentials to the device. Once the device decrypts these chosen credentials, the attacker would be able to cause the session authentication process (e.g., the SRP authentication process described earlier) to succeed (using knowledge of the second key in the user's credential bundle, e.g., SRP x), and would be able to craft a false keychain complete with attacker chosen vault keys, and false item data encrypted with those keys. The client may then accept these keys, and use them to encrypt any newly uploaded data.

### Exploit Outline

1. An attacker (whether MiTM or a malicious vault service provider server) must learn the client's device public key: pub
2. An attacker generates values for the user's first key and second key (auk,x). The goal of the attacker is now to convince the client to use these values.
3. An attacker encrypts their generated first key and second key using pub, which for the purposes of this discussion will be referred to as encCreds.
4. When a client requests their encrypted credential bundle from the vault service provider server the attacker will respond with encCreds instead of the legitimate encrypted credentials.
5. The client will decrypt encCreds using their device private key, obtaining x and auk (which are known to the attacker).
6. The client will perform the session authentication process (e.g., SRP) using x which is known to the attacker, and the attacker will respond as if it is the server, using the calculated verifier for the chosen x value v: =g^{x}. In this scenario the session authentication process will complete successfully because the attacker can impersonate the server using v.
7. At this point the client has authenticated “successfully”, and the attacker and the client share a session key derived from the session authentication process. The attacker can use this session key to authenticate any subsequent communications with the client.
8. The attacker can generate false plaintext item data, as well as false vault keys to encrypt this data with. The attacker can also generate a false keychain, ultimately encrypted using auk.
9. The attacker can send this false data to the client, which will cause the client to decrypt the attacker supplied vault keys (and any false items), decrypting this keychain using auk.
10. A client who can be convinced to encrypt new data will use the attacker supplied vault keys from the false keychain, and then will send this encrypted data to the attacker. Because the attacker has knowledge of these false vault keys, they are able to decrypt the new item data.

### Issue #2: Attacks on Credential Exchange

An additional shortcoming in the credential exchange process for additional devices (referred to herein as “Additional Device Enrollment”) that could potentially be exploited if public key cryptography were used to encrypt/decrypt a user's credential bundle relates to a MiTM attacker (possibly a malicious vault service provider server) being able to perform a key substitution attack during the exchange of the user's credentials (i.e., the user's first key and second key). By performing this key substitution, the attacker would be able to learn the active values of the user's first key and second key. The following sequence of events illustrates the actions by the vault service provider server (identified as VSP), an existing trusted device (identified as c1), and a new enrolling device (identified as c2) in this second potential exploit:

| | |
|---|---|
| c2 -> VSP | : pub |
| VSP | : pub_f, priv_f := keygen( ) |
| VSP -> c1 | : pub_f |
| c1 | : salt := rand_bytes( ) |
| | enc_s := enc(pub_f, salt) |
| c1 -> VSP | : enc_s |
| VSP | : salt := dec(priv_f, enc_s) |
| | enc_f := enc(pub, salt) |
| VSP -> c2 | : enc_f |
| c2 | : salt := dec(priv, enc_f) |
| | v := PBKDF2(code, salt) |
| c2 -> VSP | : v |
| VSP -> c1 | : v |
| c1 | : v == PBKDF2(code, salt) |

Once the existing trusted device (i.e., c1) computes its verifier v and compares it to the value relayed by the vault service provider (i.e., VSP), the following may occur (following the attack to its conclusion):

| | |
|---|---|
| c1 | : enc_creds := enc(pub_f, (srp_x, auk)) |
| c1 -> VSP | : enc_creds |
| VSP | : srp_x, auk := dec(priv_f, enc_creds) |
| | enc_creds_f := enc(pub, (srp_x, auk)) |
| VSP -> c2 | : enc_creds_f |

The attacker is not only able to obtain the user's first key (i.e., AUK) and the second key (i.e., SRPx), but is able to do so without any detection (since it can successfully relay these values to c2).

However, the use of symmetric key cryptography to encrypt/decrypt users' credentials using symmetric device keys as described herein effectively mitigate against attacks #1 and #2, outlined above. In particular, the use of symmetric key cryptography as described herein ensures that a MiTM attacker (who could be a malicious vault service provider server) does not have the ability to influence or obtain a user's second key (i.e., the user's session authentication key), first key (i.e., the user's account unlock key) or to directly control the values of these a client will use.

As described earlier, in embodiments of the present disclosure the device key used to encrypt/decrypt a user's credentials may be any suitable symmetric key such as, for example, a 256-bit value generated using a CSPRNG at time of device enrollment. This key will have a key identifier (KID) which will be “public” (known to the vault service provider and the network).

In some embodiments, the device key only permits the key operation “deriveKey” (if stored as a JWK), or otherwise the client may be configured to enforce that the device key only be used for derivation of subkeys (but not used for encryption or any other cryptographic operation directly). For example, in such embodiments the only permitted cryptographic operation for the device key may be as input key material (ikm) through a key derivation function, such as HKDF. In such embodiments, only derived keys are used for long-term credential encryption. In addition, in some embodiments the input to the key derivation function may also be required to include a protocol unique domain separation string within the info string.

This constraint is introduced to ensure domain separation at the key level, and allows for future uses of the device-known symmetric key, without needing to consider implications of compatible raw cryptographic material between protocol interactions (because any other protocols will have their own subkey). For example, in order to guard against cross protocol interactions: up to and including compromise of cryptographic key associated with another protocol, domain separation may be used both during key derivation (to ensure different keys for different purposes) and during encryption and decryption to authenticate expectations about the purpose of a ciphertext. This means that the device key can potentially be used safely in other protocols (by generating subkeys for those protocols) without compromising the security of the protocols described herein.

Two very specific examples of symmetric encryption of a credential bundle and symmetric decryption of an encrypted credential bundle are described below. It should be understood that these examples are in no way limiting and that other symmetric key cryptography processes for the cryptographic protection of users' credentials are contemplated within the scope of the present disclosure. It is noted that in the description of the following examples ∥ is taken to mean “concatenate” (not the logical OR). In addition, in the description of the following examples, the first key and the second key in the user's credential bundle are identified as auk and srp_x, respectively.

### Encrypting a Credential Bundle

The following provides one example of how the symmetric encryption of a user's credential bundle using a device key may be performed in accordance with an embodiment of the present disclosure. For example, the following symmetric encryption process, or something substantially similar, may be utilized in step 350 of FIG. 3D, steps 386 and 390 of FIG. 3F and/or step 430 of FIGS. 4 and 7.

Given a credential bundle (srp_x, auk), input key material ikm, key ID kid, an info string i and an optional encrypted credential bundle format specifier v (If v is unspecified, it will be the empty string):
1. Derive the “Credential Bundle Encryption Key” k Using HKDF Over Ikm, Kid, and i:

```
k = hkdf_sha384(
  len = 32,
  ikm = ikm,
  info = “CREDENTIAL_BUNDLE_KEY:” | | i,
  salt = kid
  )
```

NOTE: ikm is usually the device key, unless performing additional device enrollment: where it may be a shared session key between the new untrusted device and the existing trusted device.
2. Encode auk and srp_x into credentials creds as follows:
   creds=json_encode({“auk”: auk, “srpx”: srp_x})
3. Encrypt the credential bundle creds using AES-256-GCM, using k as the key with additional data defined in the following:

```
iv = random_bytes(12)
ciphertext, tag = aes256_gcm_encrypt(
  plaintext = creds,
  iv = iv,
  additional_data = “CREDENTIAL_BUNDLE:” | | i | | v,
  key = k
)
```

4. Combine the ciphertext and related data into the JweB format as follows:

```
jweb = {
  kid: kid,
  enc: “AES-GCM”,
  cty: “b5+jwk+json”,
  iv: iv,
  data: ciphertext | | tag,
}
```

### Decrypting an Encrypted Credential Bundle

The following provides one example of how the symmetric decryption of a user's encrypted credential bundle using a device key may be performed in accordance with an embodiment of the present disclosure. For example, the following symmetric decryption process, or something substantially similar, may be utilized in step 332 of FIG. 3C, step 388 of FIG. 3F, step 568 of FIG. 5, step 670 of FIG. 6 and/or step 430 of FIGS. 4 and 7.

Given an encrypted credential jweb, parsed in the JweB format, input key material ikm, key ID kid, an info string i and an optional encrypted credential bundle format specifier v (The encrypted credential bundle format specifier will be provided alongside the JweB, and should be passed into this process. If v is unspecified, it will be the empty string):
1. Extract the following based on their JSON key names from jweb:
   {kid: kid_jweb, enc, cty, iv, data}=jweb
2. Assert the following:
   kid==kid_jweb
   enc==“AES-GCM”
   cty==“b5+jwk+json”
   bytes_len(iv)==12
   bytes_len(data)>=32
3. Separate the ciphertext and tag by setting tag to be the last 16 bytes of data, and setting ciphertext to be the leftmost bytes before but not including the final 16.
   ciphertext=data[0:len(data)−16)
   tag=data [len (data)−16:len(data)]
4. Derive the “credential bundle encryption key” k using HKDF over ikm, kid, and i:

```
k = hkdf_sha384(
  len = 32,
  ikm = ikm,
  info = “CREDENTIAL_BUNDLE_KEY:” | | i,
  salt = kid
)
```

5. Decrypt ciphertext into credential bundle creds using AES-256-GCM, using k as the key with additional data defined in the following:

```
creds = aes256_gcm_decrypt(
  ciphertext = ciphertext,
  tag = tag,
  iv = iv,
  additional_data = “CREDENTIAL_BUNDLE:” | | i | | v,
  key = k
)
```

NOTE: In some embodiments, if a decryption failure occurs, a client application may require manual intervention from the user before retrying a decryption.
6. Parse creds into the following JSON structure, to obtain the credentials auk and srp_x:
   {“auk”: auk, “srp_x”: srp_x}=json_parse(creds)

Although many of the detailed embodiments discussed above have been described in the context of providing SSO and/or passwordless sign-on to a vault provided by a vault service provider, aspects of the present disclosure are also applicable to other types of web services. For example, in some implementations, aspects of the present disclosure are leveraged to provide SSO and/or passwordless sign-on to other types of web services including, but not limited to cloud-based end-to-end encrypted versions of: file hosting providers; backup services; document storage/productivity suites; note-taking applications; video and/or image editing services; and messaging services.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, certain technical solutions of the present disclosure may be embodied in the form of a software product. A suitable software product may be stored in a pre-recorded storage device or other similar non-volatile or non-transitory computer readable medium, for example. The software product includes instructions tangibly stored thereon that enable a processing device (e.g., a microprocessor) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

Although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more and the singular also includes the plural unless it is obvious that it is meant otherwise.

Further, use of the term “plurality” is meant to convey “more than one” unless expressly stated to the contrary.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Circuitry, as used herein, may be analog and/or digital, components, or one or more suitably programmed microprocessors and associated hardware and software, or hardwired logic. Also, “components” may perform one or more functions. The term “component,” may include hardware, such as a processor, an application specific integrated circuit (ASIC), or a field programmable gate array (FPGA), or a combination of hardware and software. Software includes one or more computer executable instructions that when executed by one or more component cause the component to perform a specified function. It should be understood that the algorithms described herein are stored on one or more non-transitory memory. Exemplary non-transitory memory includes random access memory, read only memory, flash memory or the like. Such non-transitory memory may be electrically based or optically based.

As used herein, the term “substantially” means that the subsequently described parameter, event, or circumstance completely occurs or that the subsequently described parameter, event, or circumstance occurs to a great extent or degree. For example, the term “substantially” means that the subsequently described parameter, event, or circumstance occurs at least 90% of the time, or at least 91%, or at least 92%, or at least 93%, or at least 94%, or at least 95%, or at least 96%, or at least 97%, or at least 98%, or at least 99%, of the time, or means that the dimension or measurement is within at least 90%, or at least 91%, or at least 92%, or at least 93%, or at least 94%, or at least 95%, or at least 96%, or at least 97%, or at least 98%, or at least 99%, of the referenced dimension or measurement.

1. A computer-implemented method for facilitating single sign-on (SSO) to a web service provider, the method comprising:
receiving, on a client device, user input to access a cryptographically protected resource provided by a web service provider;
redirecting a user on the client device to perform a login to an identity provider;
receiving, from the identity provider, a response to the login to the identity provider;
sending the response from the identity provider to the web service provider;
after the web service provider confirms validity of the identity of the user by the identity provider, receiving information conveying an encrypted credential bundle from the web service provider, the encrypted credential bundle corresponding to the user and the client device, wherein the encrypted credential bundle is symmetrically encrypted using a device key previously generated on the client device and corresponding to the user and the client device, the encrypted credential bundle including at least an encrypted first key;
retrieving, from local storage on the client device, the device key corresponding to the user and the client device;
decrypting the encrypted credential bundle using the device key to obtain the first key; and
using the first key to access the cryptographically protected resource provided by the web service provider.

2. The method of claim 1, wherein the encrypted credential bundle further includes at least an encrypted second key, the method further comprising:
decrypting the encrypted credential bundle using the device key to obtain the second key; and
using the second key to establish an authorized session for communication between the web service provider and the client device.

3. The method of claim 1, wherein:
the web service provider is a vault service provider;
the cryptographically protected resource is a vault provided by the vault service provider; and
using the first key to access the cryptographically protected resource provided by the web service provider comprises using the first key to decrypt an encrypted chain of keys to unlock the vault provided by the vault service provider.

4. The method of claim 1, wherein:
the encrypted credential bundle is symmetrically encrypted with a symmetric encryption key derived from the device key; and
decrypting the encrypted credential bundle using the device key comprises:
i) deriving a symmetric decryption key using the device key; and
ii) decrypting the encrypted credential bundle with the symmetric decryption key.

5. The method of claim 2, further comprising:
after the web service provider confirms validity of the identity of the user by the identity provider, receiving information from the web service provider conveying a session identifier corresponding to an unverified session between the web service provider and the client device, wherein using the second key to establish an authenticated session for communication with the web service provider comprises using the second key to authenticate the unverified session corresponding to the session identifier received from the web service provider.

6. The method of claim 2, wherein using the second key to establish an authenticated session for communication with the web service provider comprises using the first key in a password authenticated key exchange (PAKE) to establish the authenticated session for communication with the web service provider without revealing the first key to the web service provider.

7. The method of claim 6, wherein using the second key in the PAKE to establish the authenticated session for communication with the web service provider comprises establishing a shared session key for end-to-end encrypted communication with the web service provider.

8. The method of claim 7, wherein the PAKE is based on a secure remote password (SRP) protocol utilizing a verifier previously generated using the second key, wherein the verifier is stored on the web service provider.

9. The method of claim 1, further comprising:
before receiving the encrypted credential bundle from the web service provider, sending a key identifier (ID) to the web service provider for use in identifying the encrypted credential bundle corresponding to the user and the client device, wherein the key ID corresponds to the device key previously generated on the client device.

10. The method of claim 9, wherein sending the key ID corresponding to the device key to the web service provider comprises:
receiving a communication from the web service provider confirming validation of the identity of the user by the identity provider; and
sending, to the web service provider, a request to provide the encrypted credential bundle corresponding to the user and the client device, wherein the request includes the key ID corresponding to the device key previously generated on the client device.

11. The method of claim 9, wherein the encrypted credential bundle corresponds to the user, the client device and a specific account of the user, the method further comprising sending an account identifier to the web service provider for use in identifying the encrypted credential bundle corresponding to the user, the client device and the specific account of the user.

12. The method of claim 1, further comprising:
after the web service provider confirms validity of the identity of the user by the identity provider, receiving a reauthentication token from the web service provider;
storing the reauthentication token on the client device in an element that is accessible via a biometric access mechanism on the client device;
prompting the user to provide biometric input via the biometric access mechanism on the client device to access the cryptographically protected resource provided by the web service provider;
in response to the user providing biometric input via the biometric access mechanism such that the reauthentication token is accessible, retrieving the reauthentication token and sending the reauthentication token to the web service provider for validation; and
after the web service provider confirms validity of the reauthentication token, receiving the encrypted credential bundle.

13. The method of claim 1, wherein, before redirecting the user on the client device to perform the login to the identity provider, performing an enrollment process to register the client device with the web service provider as a trusted device for SSO for the user, the enrollment process comprising:
receiving, on the client device, user input to access the cryptographically protected resource provided by the web service provider;
redirecting the user on the client device to perform a login to the identity provider;
receiving, from the identity provider, a response to the login to the identity provider;
sending the response from the identity provider to the web service provider;
after the web service provider confirms validity of the identity of the user by the identity provider, generating the device key corresponding to the user and the client device;
generating the first key;
encrypting the first key using the device key to generate the encrypted credential bundle; and
sending the encrypted credential bundle to the web service provider for storage in association with the user and the client device.

14. The method of claim 13, wherein encrypting the first key using the device key comprises:
deriving a symmetric encryption key using the device key; and
encrypting the first key with the symmetric encryption key to generate the encrypted credential bundle.

15. The method of claim 2, wherein, before redirecting the user on the client device to perform the login to the identity provider, performing an enrollment process to register the client device with the web service provider as a trusted device for SSO for the user, the enrollment process comprising:
generating a verifier using the second key; and
sending the verifier to the web service provider for storage in association with the user and the client device for use in establishing the authenticated session for communication between the web service provider and the client device.

16. The method of claim 1, wherein the client device is a first client device registered with the web service provider as a trusted device for the user, the method further comprising:
receiving a notification from the web service provider indicating a second client device has requested to be registered with the web service provider as a trusted device for the user;
establishing a shared secret with the second client device; and
using the shared secret in a password authenticated key exchange (PAKE) with the second client device to establish a session key for end-to-end encrypted communication with the second client device via the web service provider, wherein neither the shared secret nor the session key is revealed to the web service provider;
encrypting a copy of the credential bundle using the session key; and
sending the encrypted copy of the credential bundle to the web service provider for retrieval by the second client device.

17. The method of claim 16, wherein encrypting the copy of the credential bundle using the session key comprises:
deriving a symmetric encryption key using the session key; and
encrypting the copy of the credential bundle with the symmetric encryption key derived using the session key.

18. The method of claim 16, wherein:
the shared secret comprises a code generated on the first client device;
establishing the shared secret with the second client device comprises displaying the code on a display of the first client device with a prompt to enter the code on the second client device; and
using the shared secret in the PAKE with the second client device comprises performing a PAKE handshake process with the second device via the web service provider using the code to establish the session key.

19. The method of claim 18, wherein the PAKE is based on a balanced composable PAKE protocol.

20. A computer-implemented method for facilitating passwordless sign-on to a web service provider, the method comprising:
receiving, on a client device, user input to access a cryptographically protected resource provided by a web service provider;
sending an authentication request to the web service provider to initiate an authentication process for a user on the client device to access the cryptographically protected resource;
receiving, from the web service provider, a passkey challenge for the user;
displaying a prompt on a display of the client device for the user to complete the passkey challenge with a passkey manager on the client device via user input on the client device;
after the user completes the passkey challenge with the passkey manager to access a passkey stored on the client device and corresponding to an account of the user's with the web service provider, receiving, from the passkey manager, a passkey assertion generated by the passkey manager using the passkey corresponding to the user's account with the web service provider;
sending the passkey assertion and a device identifier corresponding to the client device to the web service provider;
after the web service provider confirms validity of the passkey assertion, receiving information conveying an encrypted credential bundle from the web service provider, the encrypted credential bundle corresponding to the user's account with the vault service provider and the client device, wherein the encrypted credential bundle is symmetrically encrypted using a device key previously generated on the client device and corresponding to the user's account with the web service provider and the client device, the encrypted credential bundle including at least an encrypted first key;
retrieving, from local storage on the client device, the device key corresponding to the user's account with the web service provider and the client device;
decrypting the encrypted credential bundle using the device key to obtain the first key; and
using the first key to access the cryptographically protected resource provided by the web service provider.

21. The method of claim 20, wherein the encrypted credential bundle further includes at least an encrypted second key, the method further comprising:
decrypting the encrypted credential bundle using the device key to obtain the second key; and
using the second key to establish an authorized session for communication between the web service provider and the client device.

22. The method of claim 20, wherein:
the web service provider is a vault service provider;
the cryptographically protected resource is a vault provided by the vault service provider; and
using the first key to access the cryptographically protected resource provided by the web service provider comprises using the first key to decrypt an encrypted chain of keys to unlock the vault provided by the vault service provider.

23. The method of claim 20, wherein:
the encrypted credential bundle is symmetrically encrypted with a symmetric encryption key derived from the device key; and
decrypting the encrypted credential bundle using the device key comprises:
i) deriving a symmetric decryption key using the device key; and
ii) decrypting the encrypted credential bundle with the symmetric decryption key.

24. The method of claim 20, wherein receiving the information conveying the encrypted credential bundle from the web service provider further comprises receiving information conveying user information and a sign-in token.

25. The method of claim 20, wherein the passkey manager is part of an operating system running on the client device or part of a web browser running on the client device.

26. The method of claim 21, further comprising:
after the web service provider confirms validity of the passkey assertion, receiving information from the web service provider conveying a session identifier corresponding to an unverified session between the vault service provider and the client device, wherein using the second key to establish an authenticated session for communication with the vault service provider comprises using the second key to authenticate the unverified session corresponding to the session identifier received from the web service provider.

27. The method of claim 21, wherein using the second key to establish an authenticated session for communication with the web service provider comprises using the second key in a password authenticated key exchange (PAKE) to establish the authenticated session for communication with the web service provider without revealing the first key to the web service provider.

28. The method of claim 27, wherein using the second key in the PAKE to establish the authenticated session for communication with the web service provider comprises establishing a shared session key for end-to-end encrypted communication with the web service provider.

29. The method of claim 28, wherein the PAKE is based on a secure remote password (SRP) protocol utilizing a verifier previously generated using the second key, wherein the verifier is stored on the web service provider.

30. The method of claim 20, wherein, before receiving the user input to access the cryptographically protected resource provided by the web service provider, performing an enrollment process to register the client device with the web service provider as a trusted device for passwordless sign-on for the user, the enrollment process comprising:
generating the device key corresponding to the user's account with the vault service provider and the client device;
generating the first key;
encrypting the first key using the device key to generate the encrypted credential bundle;
sending the encrypted credential bundle to the web service provider for storage in association with the user's account with the web service provider and the client device;
receiving, on the client device, user input to register the client device with the web service provider as a trusted device for passwordless sign-on for the user;
sending a passkey registration request to the web service provider to initiate a passkey registration process for the user's account with the web service provider, the passkey registration request including an account identifier corresponding to the user's account with the web service provider;
receiving, from the web service provider, a passkey registration challenge for the user;
displaying a prompt on a display of the client device for the user to complete the passkey registration challenge with the passkey manager on the client device via user input on the client device;
after the user completes the passkey registration challenge with the passkey manager to create and store, on the client device, the passkey corresponding to the user's account with the web service provider, sending a public key credential corresponding to the passkey to the web service provider for use in confirming validity of passkey assertions generated using the passkey corresponding to the user's account with the web service provider.

31. The method of claim 30, wherein encrypting the first key using the device key comprises:
deriving a symmetric encryption key using the device key; and
encrypting the first key with the symmetric encryption key to generate the encrypted credential bundle.

32. The method of claim 21, wherein, before receiving the user input to access the cryptographically protected resource provided by the web service provider, performing an enrollment process to register the client device with the web service provider as a trusted device for passwordless sign-on for the user, the enrollment process comprising:
generating a verifier using the second key; and
sending the verifier to the web service provider for storage in association with the user's account with the web service provider for use in establishing the authenticated session for communication between the web service provider and the client device.

33. The method of claim 20, wherein the client device is a first client device registered with the web service provider as a trusted device for passwordless sign-on for the user, the method further comprising:
receiving a notification from the web service provider indicating a second client device has requested to be registered with the web service provider as a trusted device for passwordless sign-on for the user;
establishing a shared secret with the second client device; and
using the shared secret in a password authenticated key exchange (PAKE) with the second client device to establish a session key for end-to-end encrypted communication with the second client device via the web service provider, wherein neither the shared secret nor the session key is revealed to the web service provider;
encrypting a copy of the credential bundle using the session key; and
sending the encrypted copy of the credential bundle to the web service provider for retrieval by the second client device.

34. The method of claim 33, wherein encrypting the copy of the credential bundle using the session key comprises:
deriving a symmetric encryption key using the session key; and
encrypting the copy of the credential bundle with the symmetric encryption key derived using the session key.

35. The method of claim 33, wherein:
the shared secret comprises a code generated on the first client device;
establishing the shared secret with the second client device comprises displaying the code on a display of the first client device with a prompt to enter the code on the second client device; and
using the shared secret in the PAKE with the second client device comprises performing a PAKE handshake process with the second device via the web service provider using the code to establish the session key.

36. The method of claim 35, wherein the PAKE is based on a balanced composable PAKE protocol.
